(19) United States
(12) Patent Application Publication
(10) Pub. No.: US 2016/0106627 A1
(43) Pub. Date: Apr. 21, 2016

(54) Systems And Methods For Medication Adherence And Acknowledgement

(71) Applicant: MONITOR MY MEDS LLC, Denver, CO (US)

(72) Inventors: Marc Nayer Geman, Denver, CO (US); Stephen L. Axelrod, Denver, CO (US)

(21) Appl. No.: 14/893,745

(22) PCT Filed: Jun. 17, 2014
(86) PCT No.: PCT/US14/42769

§ 371 Date: Nov. 24, 2015

Related U.S. Application Data
(60) Provisional application No. 61/835,880, filed on Jun. 17, 2013.

(51) Int. Cl. A61J 7/04; G06F 19/00

(52) U.S. Cl. CPC A61J 7/0409; A61J 7/0481; G06F 19/3462; A61J 2200/30

(57) ABSTRACT

Systems and methods for improving mediation adherence are provided. Various embodiments of the present invention help patients maintain their medication and other healthcare schedules and avoid costly nursing, home health care, assisted living, or nursing home alternatives whenever possible. In some embodiments, personalized recorded voice messages are used to directly contact (e.g., by telephone, VoIP, etc.) a patient when scheduled. The system can provide notifications (e.g., e-mails, text messages, automated phone calls, etc.) to a caregiver or other designated persons if the call is not acknowledged so that someone can follow up before more serious consequences arise. In addition, various reports can be generated regarding potential medication adherence and acknowledgement of the personalized voice messages. One or more rewards may be presented to the patient based on medication adherence.

### CROSS-REFERENCE TO RELATED APPLICATIONS

This application claims priority to U.S. Provisional Application No. 61/835,880, filed Jun. 17, 2013, which is incorporated herein by reference in its entirety for all purposes.

### TECHNICAL FIELD

Various embodiments of the present invention generally relate to medication adherence. More specifically, some embodiments of the present invention relate to systems and methods for medication adherence and acknowledgement.

### BACKGROUND

Medication adherence generally refers to whether the patients take their medications as prescribed. Lack of medication adherence is a concern to clinicians and other healthcare entities (e.g., insurers) due to the potential adverse outcomes and the resulting higher costs of care. For example, in order for medications to be effective, patients must take the medications as prescribed. Some estimates indicate that around thirteen percent of our total healthcare expenditures are due to poor medication adherence and its consequences. In addition, clinicians are left without the necessary feedback regarding how closely a patient is following the prescribed medication schedule. As such, clinicians cannot easily determine if the prescribed medication is ineffective because of non-compliance or for other reasons.

Various studies have found that well over fifty percent of individuals sixty-five and over admit forgetting to take their medications. While forgetfulness is one reason for lack of medication adherence, the problem is only exacerbated with a patient that has complicated medication schedules (e.g., resulting from multiple treatment regimens). While it is almost impossible for caregivers to be constantly present at their patient's home, it is clear that medication adherence promotes both good health and independence. Many traditional systems fail to effectively remind and track medication adherence.

### SUMMARY

Systems and methods are described for medication adherence and acknowledgement. In some embodiments, a method includes receiving, at a monitoring platform, a request to monitor medication adherence of a patient. The request to monitor medication adherence may include a variety of information such as, but not limited to, a patient identifier identifying the patient, a medication identifier identifying a medication, and a dispensing schedule identifying dispensing times. The request may originate from a variety of third parties such as doctors, pharmacies, third-party caregivers, and the like. The request to monitor medication adherence of the patient may be stored in a database associated with the monitoring platform. In some cases, the database includes a patient profile and the request is added to the patient profile.

The monitoring platform can determine if a dispensing time indicated in the dispensing schedule is within a predetermined time interval (e.g., within five minutes, ten minutes, etc.) or has occurred. Upon detecting the dispensing time is within the predetermined time interval or has occurred, a communication channel (e.g., traditional telephone call, text message, video call, e-mail with embedded video or audio, social media application, mobile device, medication dispensing device, etc.) to communicate with the patient can be selected. The selection of the communication channel can be based on the patient profile, time of day, patient preference, statistical assessment of channels with the most responses, and/or other factors.

The monitoring platform can generate a customized reminder message that includes a recording (e.g., video or audio) of an individual trusted by the patient reminding the patient to adhere to the dispensing schedule and requesting the patient to provide feedback regarding compliance. Using the communication channel, the customized reminder message can be transmitted to the patient. The communication channel (or alternate communication channel) can be monitored to determine if the patient provides feedback regarding compliance in response to receiving the customized reminder message. The feedback provided by the patient can be recorded and used to generate a compliance record. A set of caregivers (i.e., one or more caregivers) associated with the patient can be notified of the feedback (or lack thereof) provided by the patient. For example, in some embodiments, at least a portion of the compliance record is communicated to the caregivers (e.g., relatives, doctors, pharmacists, etc.). The set of caregivers may occur immediately (e.g., as quickly as the system can generate a communication, within a timeframe such as an hour, etc.) when the patient fails to provide feedback or the feedback includes an indication of non-compliance. In other embodiments, one or more caregivers may be notified immediately when the medication is associated with an adherence level priority rating above a threshold and the patient fails to provide feedback or the feedback includes an indication of non-compliance. If the adherence level priority rating is below a threshold, the set of caregivers may be notified on a predetermined schedule (e.g., weekly or monthly).

In some embodiments, the set of caregivers to be notified may be determined. For example, a first caregiver may be selected and notified and one or more other caregivers may only be notified if the first caregiver does not respond.

Various embodiments include a computer (or device) implemented method that includes determining if a patient should be contacted with a customized reminder message. The customized reminder message can include a recording (e.g., video recording or audio recording) of an individual trusted by the patient reminding the patient to take a medication and requesting the patient provide feedback regarding compliance. In other embodiments, the customized reminder message may be computer-generated based on a voice profile of an individual. The customized reminder message can be transmitted (e.g., via a network) to the patient. A determination can be made as to whether the patient acknowledges the customized reminder message or not. The determination can include multiple levels of response. For example, when the customized reminder message is transmitted using a telephone, a first level of acknowledgement may be whether the patient answered the phone. The second level of acknowledgement may be a voice response indicating that the patient will or has taken the medication. A third level of acknowledgment may include a signal from a medication dispensing device. Of course, a variety of other and/or different acknowledgment levels may be used by various embodiments. A lack of acknowledgment of the customized reminder message may be communicated (e.g., immediately) to a caregiver associated with the patient. For example, the lack of acknowledgment may be communicated immediately when the medication has an adherence level priority rating above a threshold or when the level of acknowledgement is below a threshold level (e.g., if the patient did not answer the phone).

Embodiments of the present invention also include computer-readable storage media containing sets of instructions to cause one or more processors to perform the methods, variations of the methods, and other operations described herein.

Various embodiments provide for a system that includes one or more processors, a message module, a communications module, a records module, a natural language processor, a rewards module, and/or a graphical user interface generation module. The message module may be running on the one or more processors and allow a caregiver to create a customized message reminding a patient to take a medication at a dispensing time. The communications module can transmit the customized message (e.g., video message, audio message written message, etc.) to a device (e.g., computer, telephone, mobile device, medication dispensing device, etc.) of the patient and determine if the patient acknowledges the customized message. The customized message also includes a reminder to perform a medical activity (e.g., record current blood pressure, measure current body weight, perform an exercise, measure body temperature, measure a pulse rate, or record qualitative indicators indicating how the patient is feeling). The results of these medical activities may be automatically recorded and communicated using smart electronics. The records module can record any acknowledgement determined by the communications module. The natural language processor can process voice responses received from the patient and determine the acknowledgment level.

The communications module can receive a dispensing schedule from a doctor, pharmacist, or other third-party identifying a medication and a set of dispensing times indicating when the patient should take the medication. The rewards module to determines a reward based on a compliance percentage over a time period. For example, the reward can include medication discounts, co-pay discounts, cash back, percentage discounts at various stores, coupons, gift cards, or other types of rewards. The graphical user interface generation module can generate various types of graphical user interfaces that allow users of the system to review submit requests for medication adherence, setup patient profiles, review compliance records, and the like.

In some embodiments, a medication adherence system can include a means for creating a medication adherence profile for a patient. The medication adherence profile may include a patient identifier identifying the patient, a medication identifier identifying a medication, a dispensing schedule identifying dispensing times for the medication, a set of caregivers, and set of criteria for notifying the caregivers. The medication adherence system may also include a means for determining if a dispensing time indicated in the dispensing schedule is within a predetermined time interval or has occurred. In addition, a means for generating a customized reminder message may also be included in some embodiments. The customized reminder message may include multiple parts and include a recording of an individual trusted by the patient reminding the patient to adhere to the dispensing schedule and a request the patient to provide feedback regarding compliance. The medication adherence system may also include a means for monitoring for feedback from the patient regarding compliance in response to receiving the customized reminder. A means for generating a compliance record based on the feedback provided by the patient may also be included in various embodiments along with a means for communicating the compliance record with the caregivers. Some embodiments also include a means for determining a reward for the patient based on the compliance record.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 illustrates an example of a web-based environment in which some embodiments of the present invention may be utilized;

FIG. 2 illustrates interactions between various users and a medication monitoring system in accordance with one or more embodiments of the present invention;

FIG. 3 is a block diagram illustrating various components of a medication monitoring system in accordance with various embodiments of the present invention;

FIG. 4 illustrates a communication flow between various components and users of a medication monitoring system in accordance with some embodiments of the present invention;

FIG. 5 illustrates a communication flow between various components and a user of a medication monitoring system with an interactive medical device in accordance with one or more embodiments of the present invention;

FIG. 6 is a flowchart illustrating a set of operations for monitoring medication adherence in accordance with various embodiments of the present invention;

FIG. 7 is a flowchart illustrating a set of operations for generating immediate notifications regarding medication adherence in accordance with various embodiments of the present invention;

FIG. 8 is a screenshot of a graphical user interface that may be used for collecting caregiver information in accordance with some embodiments of the present invention;

FIG. 9 illustrates a screenshot of a graphical user interface that may be used for collecting information regarding an individual to be monitored in accordance with one or more embodiments of the present invention;

FIG. 10 illustrates a graphical user interface that may be used for collecting notification information in accordance with various embodiments of the present invention;

FIG. 11 illustrates a screenshot of a graphical user interface that may be used in accordance with some embodiments of the present invention;

FIG. 12 illustrates a screenshot of a graphical user interface that may be used for collecting caregiver information in accordance with one or more embodiments of the present invention;

FIG. 13 illustrates a screenshot of a graphical user interface that may be used in accordance with various embodiments of the present invention;

FIG. 14 illustrates a screenshot of a graphical user interface that may be used in accordance with some embodiments of the present invention;

FIG. 15 illustrates a screenshot of a graphical user interface that may be used in accordance with one or more embodiments of the present invention;

FIG. 16 illustrates a screenshot of a graphical user interface that may be used in accordance with various embodiments of the present invention;

FIG. 17 illustrates a screenshot of a graphical user interface that may be used in accordance with some embodiments of the present invention;

FIG. 18 illustrates a screenshot of a graphical user interface that may be used in accordance with one or more embodiments of the present invention;

FIG. 19 illustrates a screenshot of a graphical user interface that may be used in accordance with various embodiments of the present invention;

FIG. 20 illustrates a screenshot of a graphical user interface that may be used in accordance with some embodiments of the present invention;

FIG. 21 illustrates a screenshot of a graphical user interface that may be used in accordance with one or more embodiments of the present invention;

FIG. 22 illustrates a screenshot of a graphical user interface that may be used in accordance with various embodiments of the present invention;

FIG. 23 illustrates a screenshot of a graphical user interface that may be used in accordance with some embodiments of the present invention;

FIG. 24 illustrates a screenshot of a graphical user interface that may be used in accordance with one or more embodiments of the present invention;

FIG. 25 illustrates a screenshot of a graphical user interface that may be used in accordance with various embodiments of the present invention;

FIG. 26 illustrates a screenshot of a graphical user interface that may be used in accordance with some embodiments of the present invention;

FIG. 27 illustrates a screenshot of a graphical user interface that may be used in accordance with one or more embodiments of the present invention;

FIG. 28 illustrates a screenshot of a graphical user interface that may be used in accordance with various embodiments of the present invention;

FIG. 29 is a sequence diagram illustrating various communications between components and users of a medication adherence system; and

FIG. 30 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention generally relate to medication adherence. More specifically, some embodiments of the present invention relate to systems and methods for medication adherence and acknowledgement. In order for medications to be effective, patients must take the medications as prescribed. For many people with complicated medication schedules and required healthcare routines, complying with these medication schedules can be difficult. Some embodiments increase a patient's ability to adhere to a desired medication schedule with an easy-to-use web-based program that provides automated reminders and monitors their compliance. In addition, some embodiments can use medication adherence in determining rewards (e.g., discounts with third-party providers such as pharmacies, point systems, raffles, etc.) which may be presented to the patient in exchange for meeting one or more levels of compliance.

In some embodiments, a web-based program allows individuals to send personal recorded healthcare messages to a patient or loved one. The messages can be delivered by telephone, for example. After the personal recorded message has been presented to the patient, the patient can be prompted to respond. Their response (e.g., by touchtone or voice), or lack thereof, to the automated call can be recorded and tracked. In some embodiments, a notification message (e.g., a text message or email) may be sent to one or more contacts. The notification message can indicate the compliance level. Various embodiments of the medication adherence system may also keep track of the patient's medication schedule and overall adherence which can be reported (e.g., emailed or faxed) to a healthcare professional, family member, or other third-party as needed.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

While, for convenience, embodiments of the present invention are described with reference to a medication adherence, embodiments of the present invention are equally applicable to monitoring and tracking compliance with various other activities and/or healthcare routines. For example, various embodiments may remind and track compliance with performing activities such as taking blood pressure, activities of daily living, appointments, and the like.

Moreover, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), application-specific integrated circuits (ASICs), magnetic or optical cards, flash memory, or other type of media/machine-readable medium suitable for storing electronic instructions.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” and the like generally mean the particular feature, structure, or characteristic following the phrase is included in at least one implementation of the present invention, and may be included in more than one implementation. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

### General Description

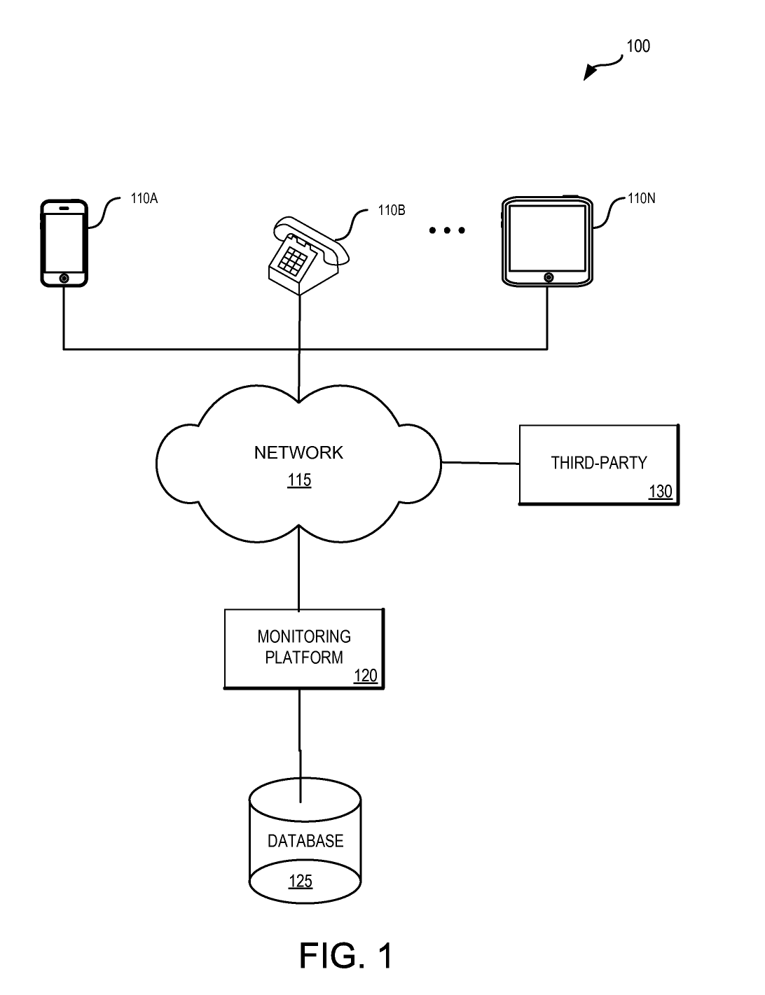

FIG. 1 illustrates an example of a web-based environment 100 which some embodiments of the present invention may be utilized. As illustrated in FIG. 1, various user devices 110A-110N can be connected through network 115 to monitoring platform 120. In accordance with various embodiments of the present invention, user devices 110A-110N can be used to setup, transfer, access, and receive services, information, and/or data associated with monitoring provided by monitoring platform 120. In some cases, user device 110A-110N may run one or more applications or clients that allow a user to interact with monitoring platform 120.

User devices 110A-110N can be any computing device capable of receiving user input as well as transmitting and/or receiving data via the network 115. In one embodiment, user devices 110A-110N can be a telephone or any device having computer functionality, such as a personal digital assistant (PDA), mobile telephone, smartphone, tablet, television, or similar device. In some cases, personalized messages for reminding a patient can be created using the user devices (e.g., via a customized application). User devices 110A-110N can be configured to communicate via network 115, which may comprise any combination of local area and/or wide area networks, using both wired and wireless communication systems. In one embodiment, network 115 uses standard communications technologies and/or protocols. Thus, network 115 may include links using technologies such as Ethernet, 802.11, worldwide interoperability for microwave access (WiMAX), 3G, 4G, CDMA, digital subscriber line (DSL), coaxial cables, hybrid fiber coaxial networks, optical connections, satellite access, plain old telephone system (PoTs), public switched telephone network (PSTN), etc.

Similarly, the networking protocols used on network 115 may include multiprotocol label switching (MPLS), transmission control protocol/Internet protocol (TCP/IP), User Datagram Protocol (UDP), hypertext transport protocol (HTTP), simple mail transfer protocol (SMTP), and file transfer protocol (FTP). Data exchanged over network 115 may be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

As illustrated in FIG. 1, monitoring platform 120 may be coupled to one or more databases 125 and/or third-parties 130. Database 125 can store information about members (or customers) of the monitoring service. For example, database 125 can include information such as medication names, medication dosage, medication schedules, contact information, emergency contact information, pharmacy information, doctor information, personalized messages, adherence records, and other information which may be used or created by monitoring platform 120. The information or summaries of the information stored within database 125 can be shared with third parties 130 in some embodiments. For example, the third party could be a pharmacy, insurance company, federal agency, doctor's office, or other.

Monitoring platform 120 can be used with almost all internet enabled devices. Personalized messages can be quickly recorded and scheduled to ring the telephone of the patient or loved one to ensure compliance with medication schedules, changes in medications, vital sign reporting, wellness calls, or healthcare appointments. Adherence to medication schedules reduces emergency healthcare costs. Most seniors have a complicated medication regimen and adherence leads to both good health and independence. Caregivers, doctors, hospitals, pharmacies, insurers, and families can use the system to monitor adherence, take action when necessary, and reward compliance (e.g., with discounts, reward points, entries into drawings, etc.).

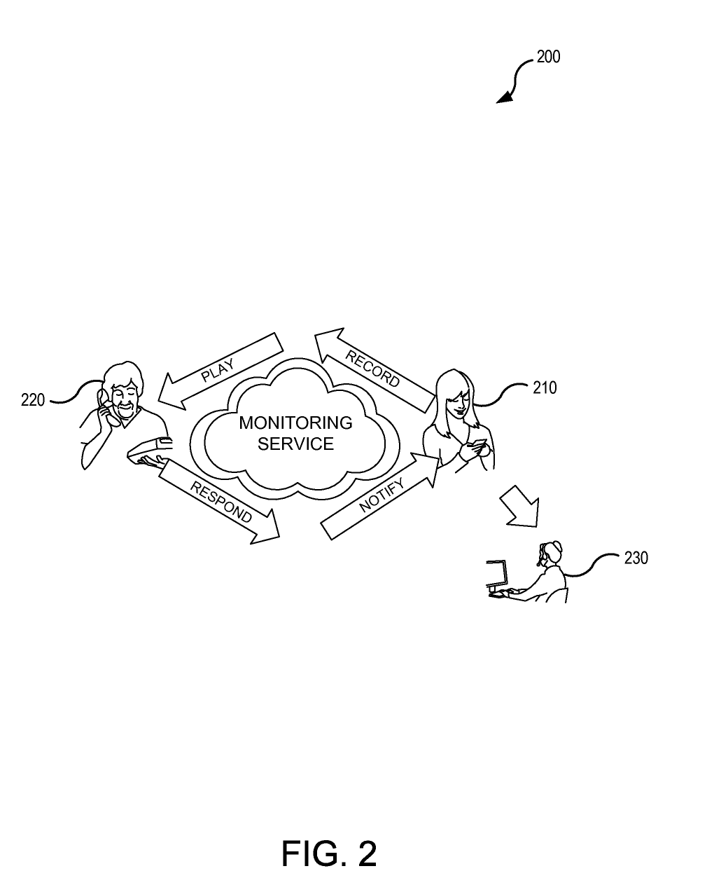

FIG. 2 illustrates interactions 200 between various users and a medication monitoring system in accordance with one or more embodiments of the present invention. As illustrated in FIG. 2, a caregiver 210 records one or more personal reminder messages for a patient. The message is stored by the monitoring service. When the monitoring service determines that patient 220 should take a medication or perform another activity, the monitoring service automatically sends one of the personal reminder messages to patient 220. The patient's response (e.g., by touchtone, e-mail, voice, etc.) to the message is recorded by the monitoring service and one or more notifications can be sent to caregiver 210. In some cases, monitoring service may also send notification messages to a monitoring company.

In various embodiments, notification rules can be configured to determine when to contact caregiver 210 and/or monitoring company 230. The notification rules can be based on the medication type, general compliance level, selected or set by caregiver 210, or other factors or preferences. For example, medications that may have serious or life threatening consequences if missed may automatically trigger a notification to the monitoring company. As another example, caregiver 210 may setup dates or times during which the monitoring service should be notified in addition to caregiver 210 (e.g., when caregiver 210 is on vacation). Still yet, some notification rules may send notifications that include summaries of compliance to monitoring company 230 on a regular schedule. The notification rules can also indicate the type of message (e.g. phone call, e-mail, SMS message, etc.) that should be generated and sent to caregiver 210 and/or monitoring company 230. The notification rules may also indicate the level of detail of information that should be provided and/or a suggested course of action.

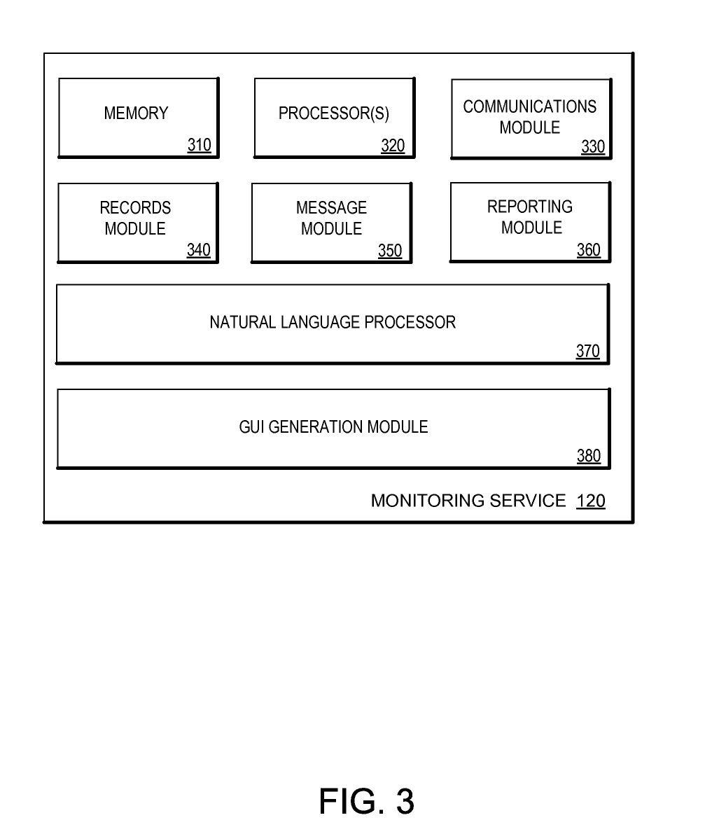

FIG. 3 is a block diagram illustrating various components of a medication monitoring platform 120 in accordance with various embodiments of the present invention. According to the embodiments shown in FIG. 3, monitoring platform 120 can include memory 310, one or more processors 320, communications module 330, records module 340, message module 350, reporting module 360, natural language processor 370, and graphical user interface (GUI) generation module 380. Other embodiments of the present invention may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, communications module 330 and message module 350 can be combined into a single module for managing communications.

Memory 310 can be any device, mechanism, or populated data structure used for storing information. In accordance with some embodiments of the present invention, memory 310 can encompass any type of, but is not limited to, volatile memory, nonvolatile memory, and dynamic memory. For example, memory 310 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory 310 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 310.

Memory 310 may be used to store instructions for running one or more applications or modules on application processor(s) 320. For example, memory 310 could be used in one or more embodiments to house all or some of the instructions needed to execute the functionality of communications module 330, records module 340, message module 350, reporting module 360, natural language processor 370, and/or GUI generation module 380.

Communications module 330, in accordance with one or more embodiments of the present invention, manages and translates any requests from a user (e.g., received through a graphical interface screen), application, service, or tool into a format required by the destination component, tool, service, and/or system. Similarly, communications module 330 may be used for generating and processing communications between modules, databases, components, subsystems, and/or systems that use different communication protocols, data formats, and/or messaging routines. In some cases, communications module 330 can be used for communicating profile information or data associated with a patient, contact, or monitoring company.

Records module 340 can record medication adherence records for each individual patient. In some embodiments, a caregiver can create a customized message using message module 350. This message can be delivered to the intended patient using communications module 330. The messages can be in any type of message format. For example, the message can be an audio message, video message, an SMS message, e-mail, etc. which can be delivered to a patient. The message may be delivered via the telephone, mobile network, VOIP, Internet, or other communication network. In response to receiving the message, a response may be requested from the patient. These responses, or lack thereof, can be recorded by records module 340 to track medication adherence. The responses can be used in calculating one or more rewards in some embodiments.

Reporting module 360 can generate one or more reports regarding patient adherence. These reports can be sent to (e.g., using communications module 330) or accessed (e.g., through a web portal) by the patient and/or other third-parties such as caregivers, medical professionals, etc. The reports can be electronically delivered in a variety of formats as requested.

Natural language processor 370 can be used to process voice responses provided by a patient. For example, one of the messages generated by message module 350 may ask the patient if they have taken their medication. A response of “I plan to,” “I have,” “remind me again in twenty minutes,” or other spoken response can be processed by natural language processor 370.

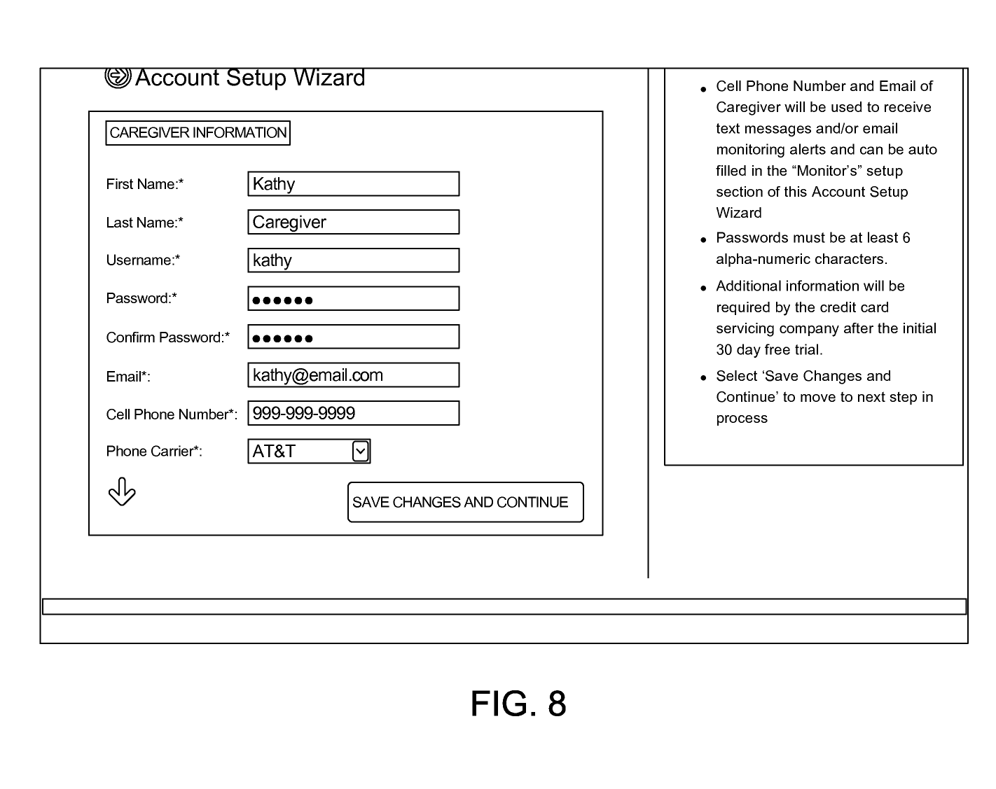

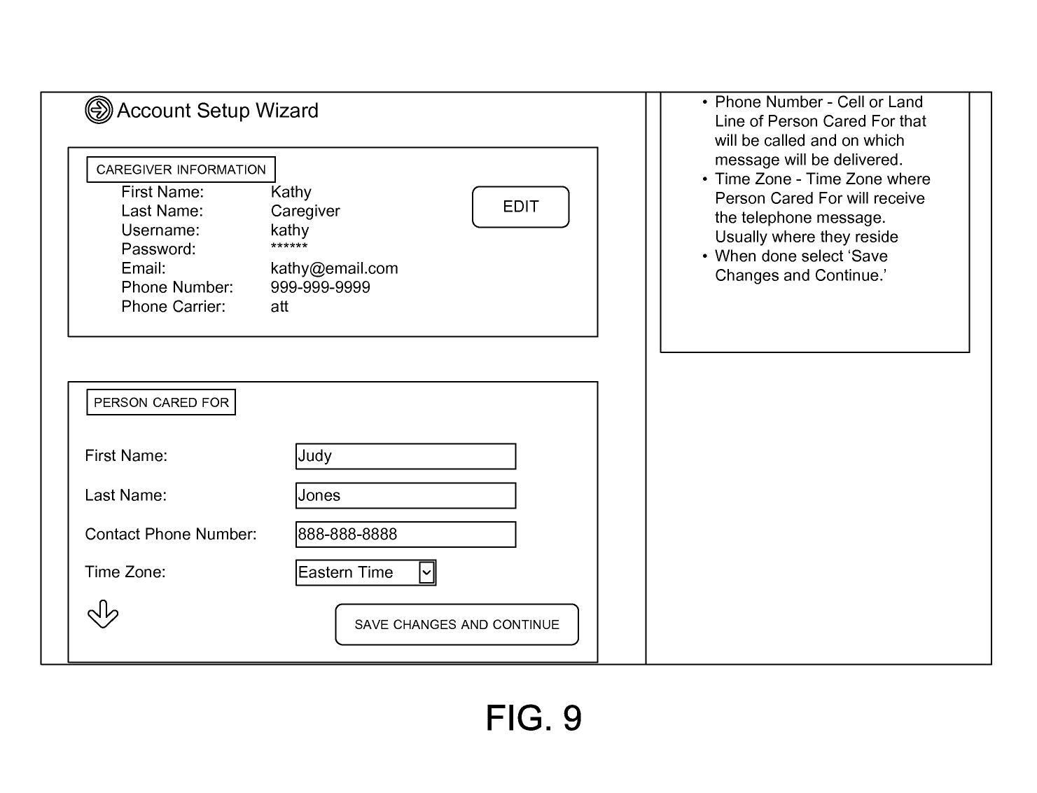

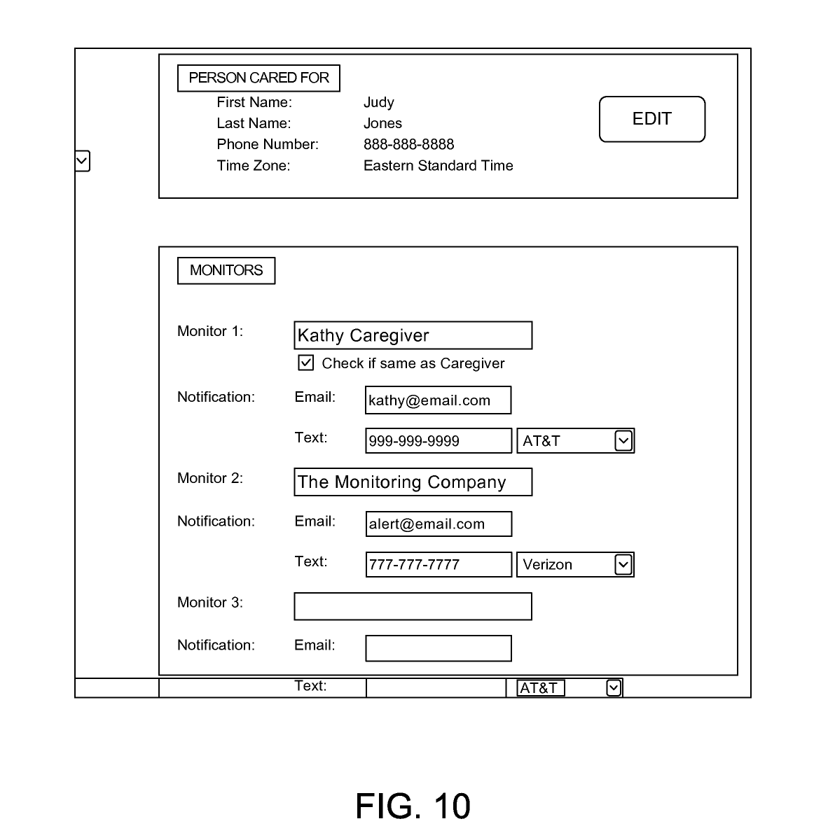

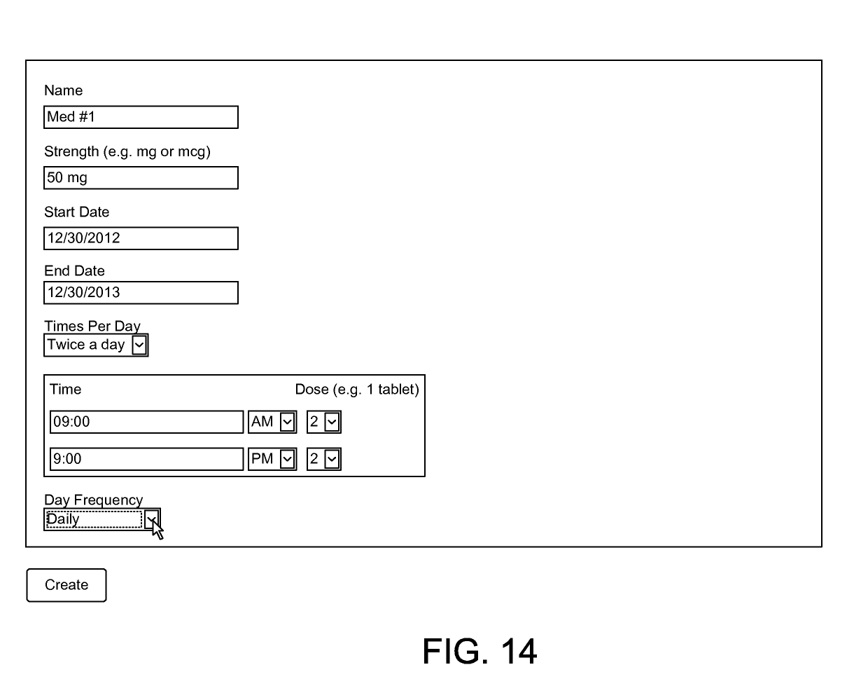

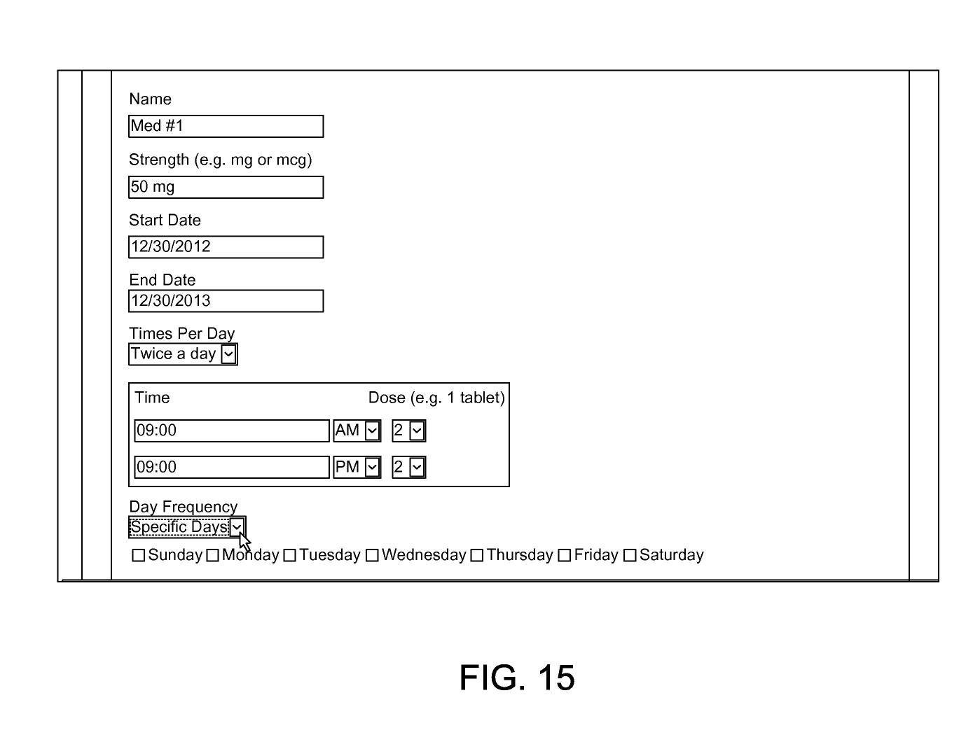

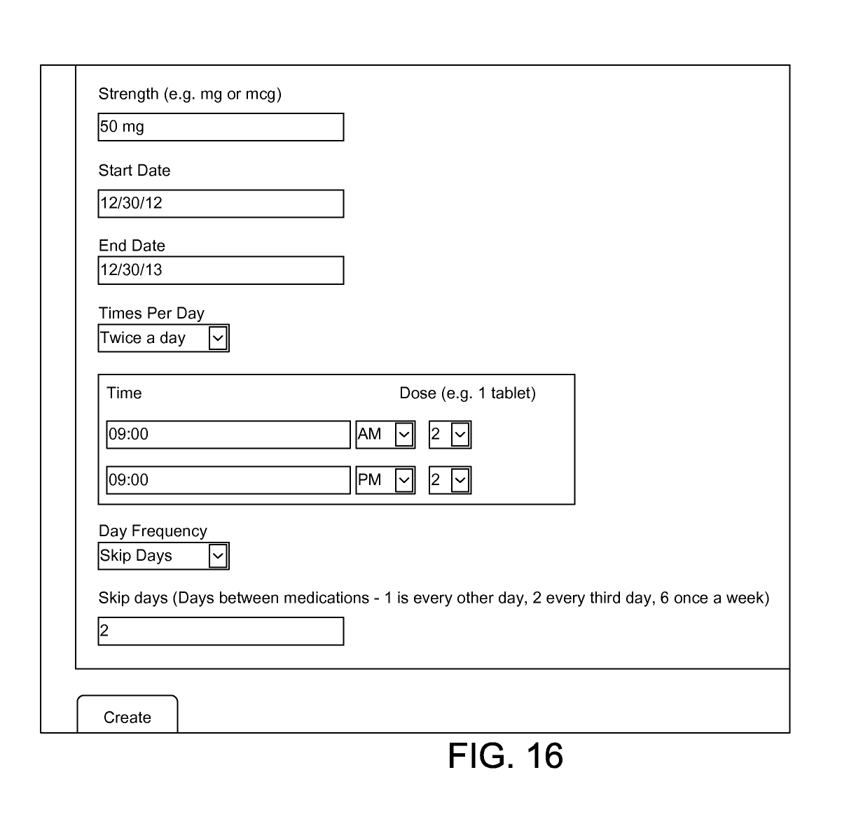

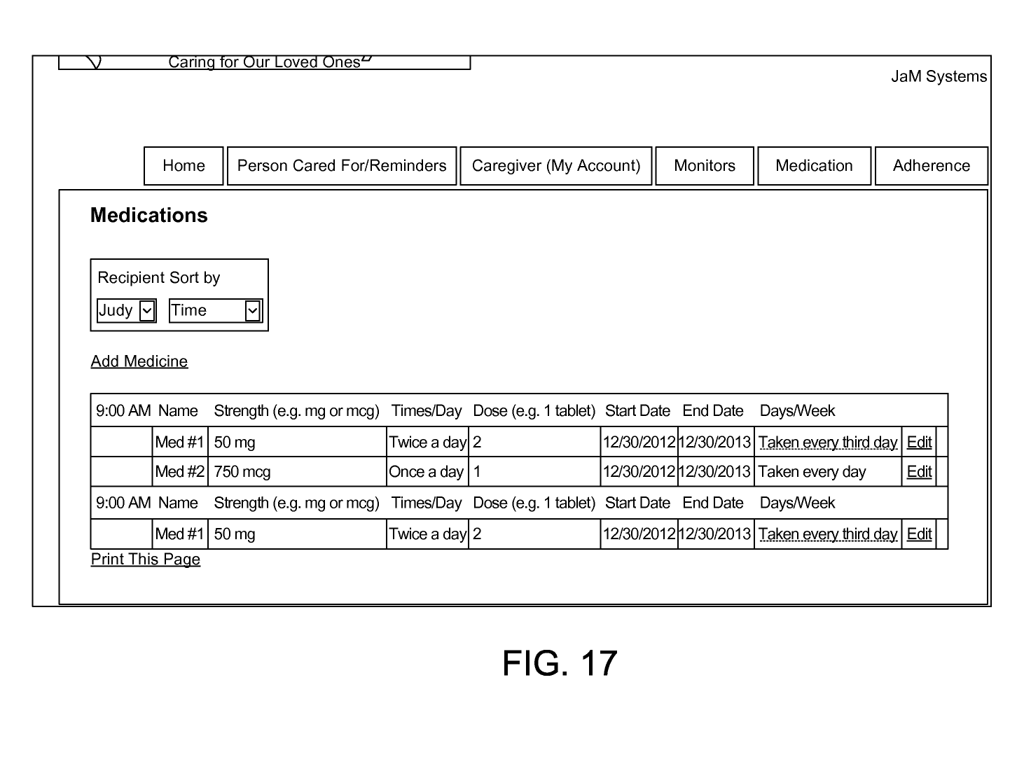

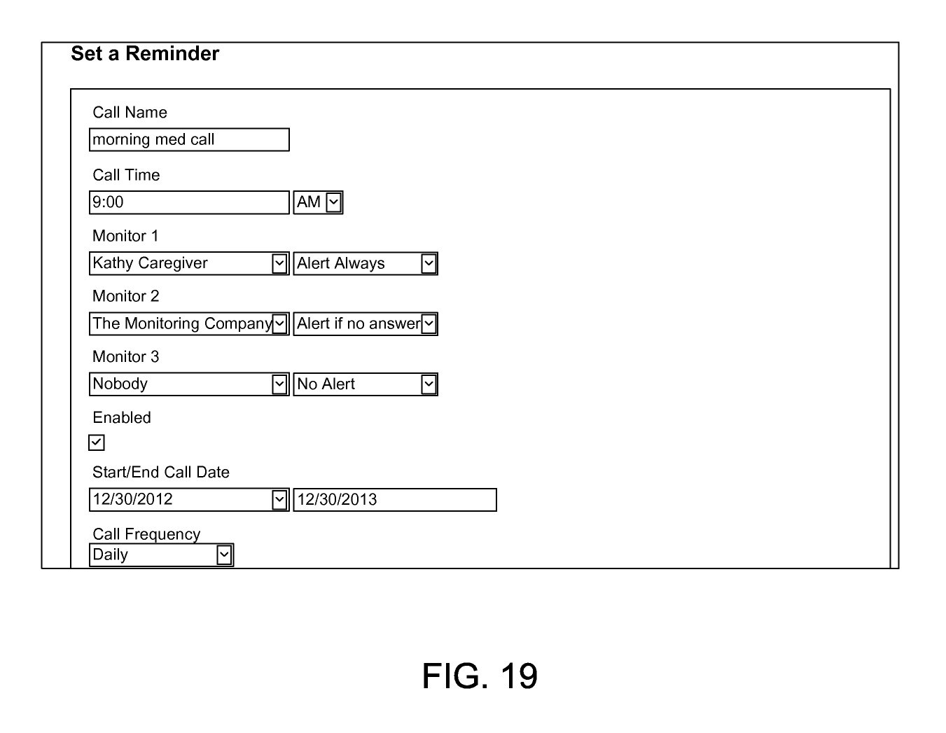

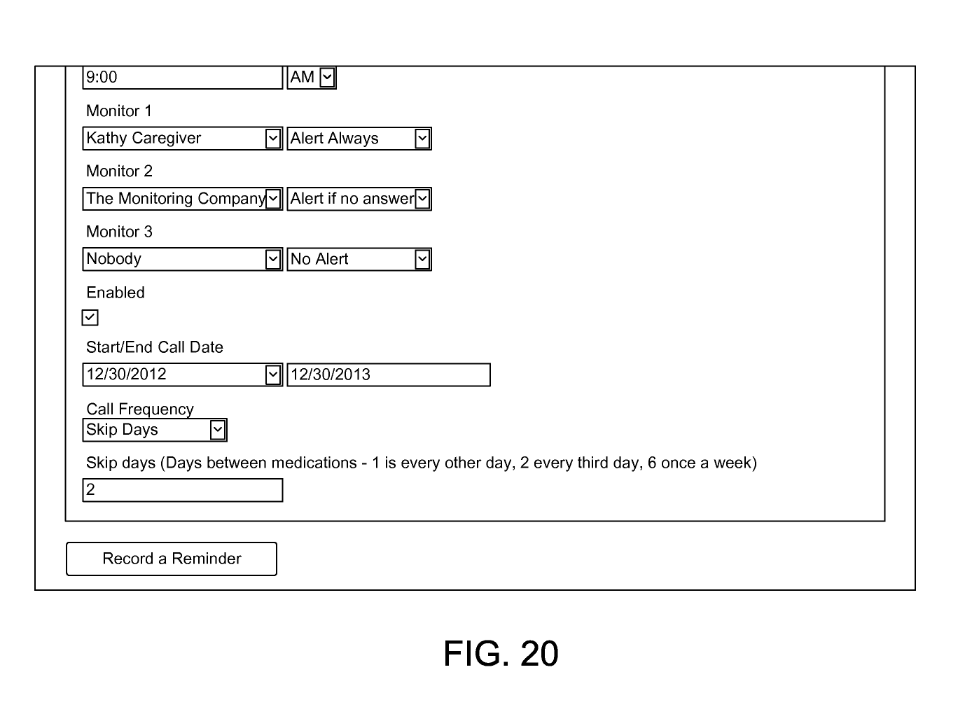

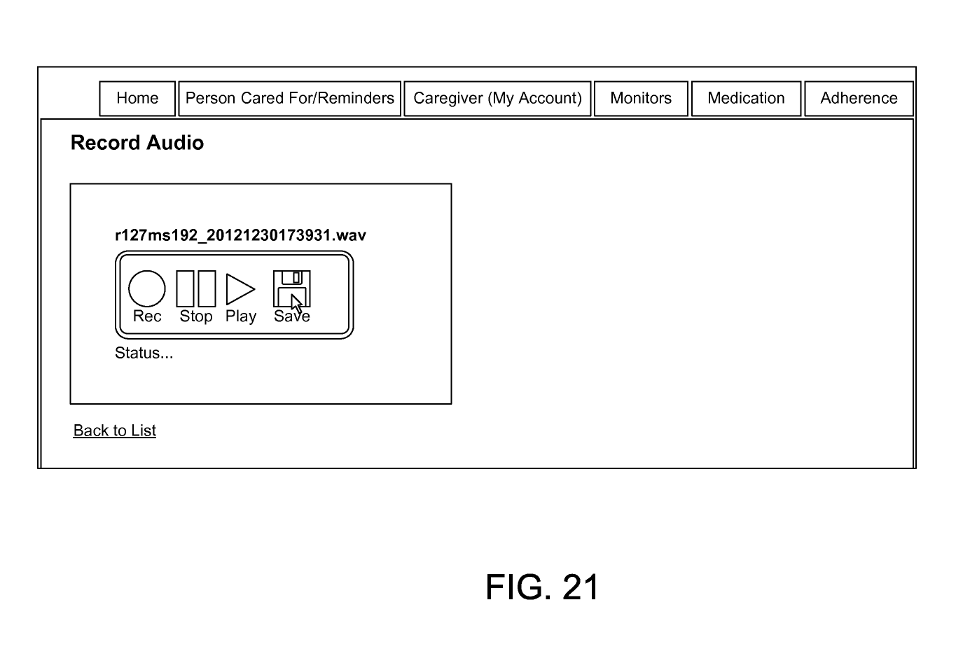

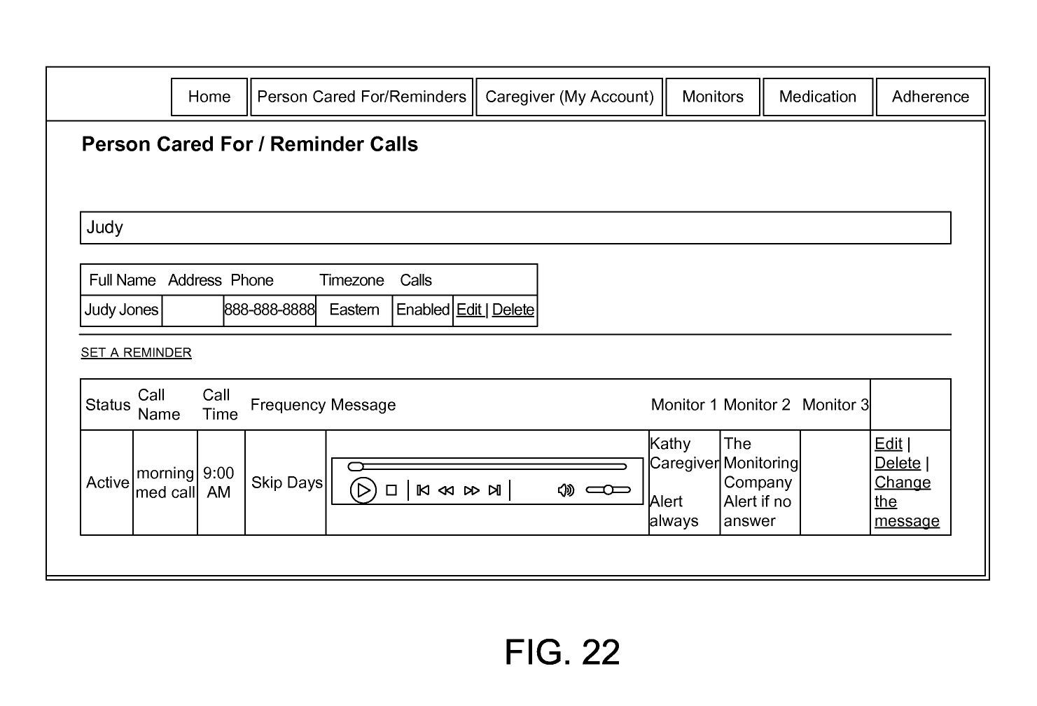

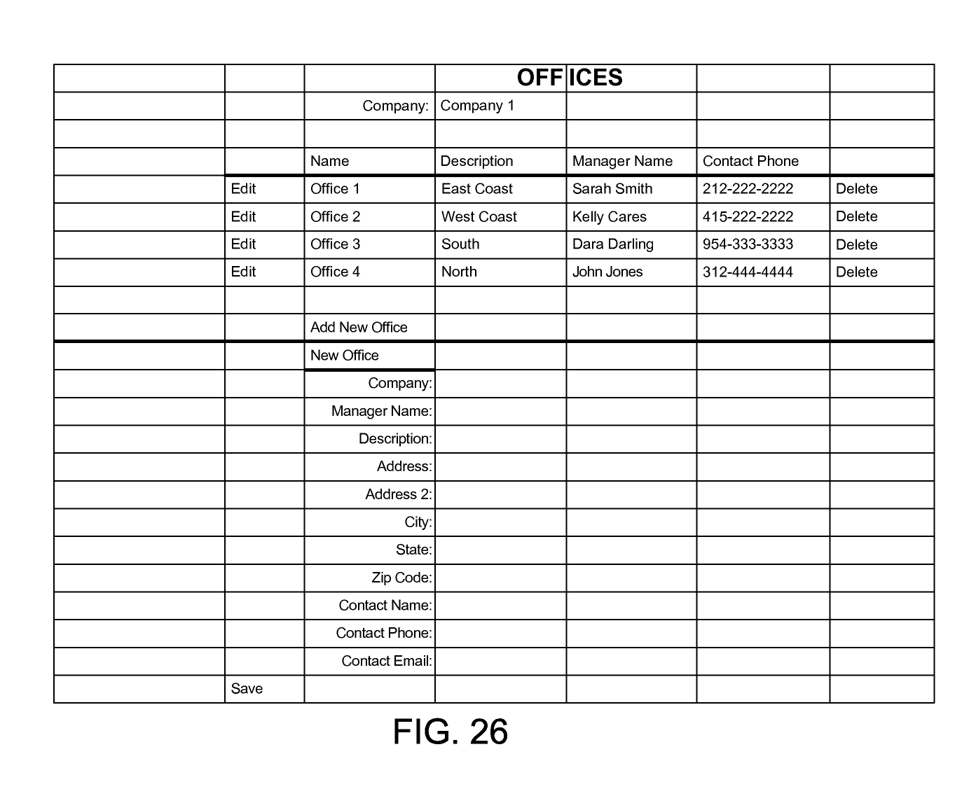

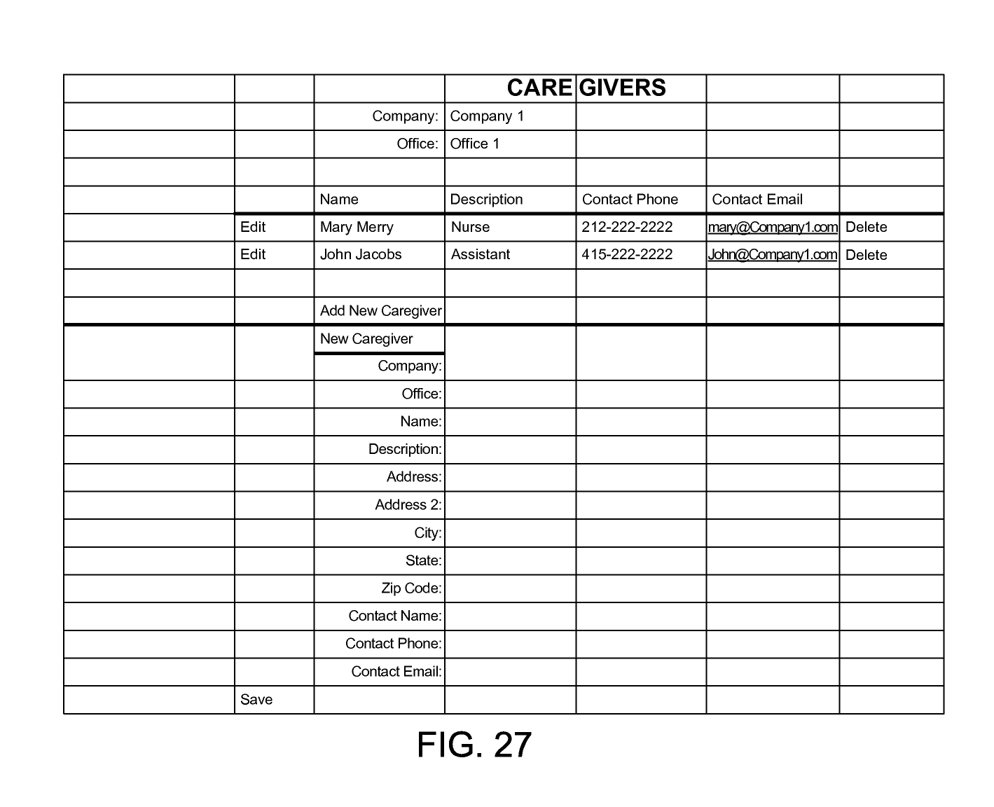

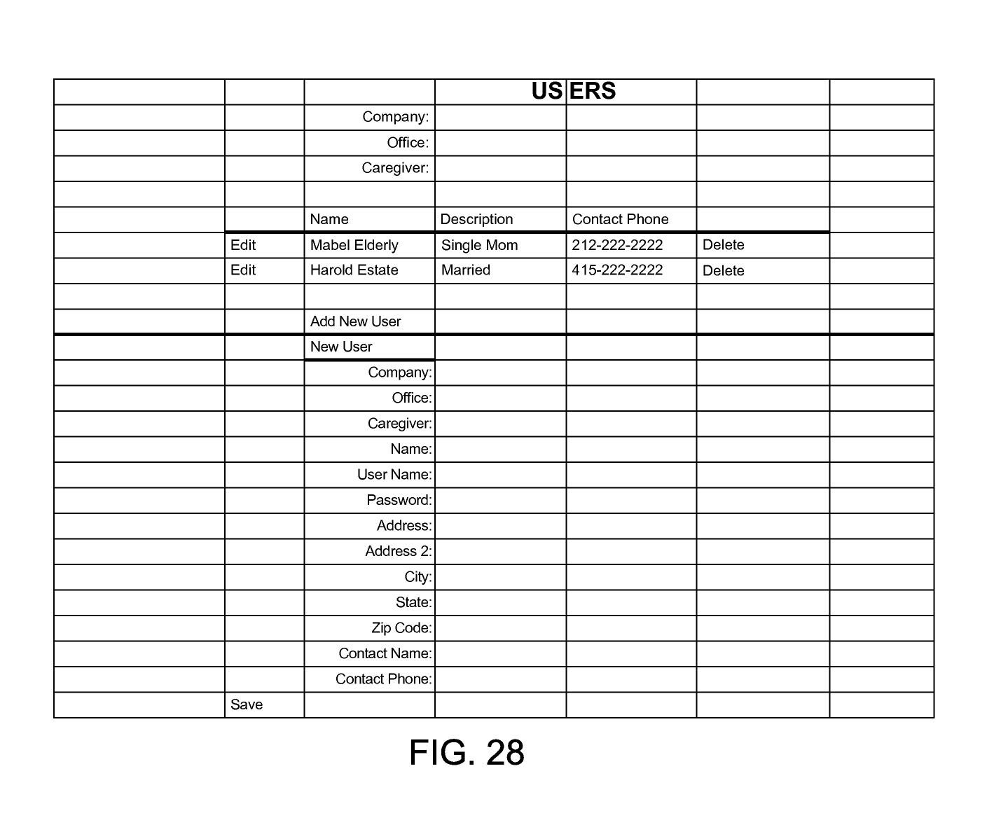

GUI generation module 380 can generate one or more GUI screens that allow for interaction with a user of the mobile device. In at least one embodiment, GUI generation module 380 generates a graphical user interface (see, e.g., FIGS. 8-28) allowing a user of the monitoring service to receive reports, generate notification rules, enter contact information, enter mediation information and schedules, prioritize contacts, set device constraints, and/or otherwise receive or convey information to the user.

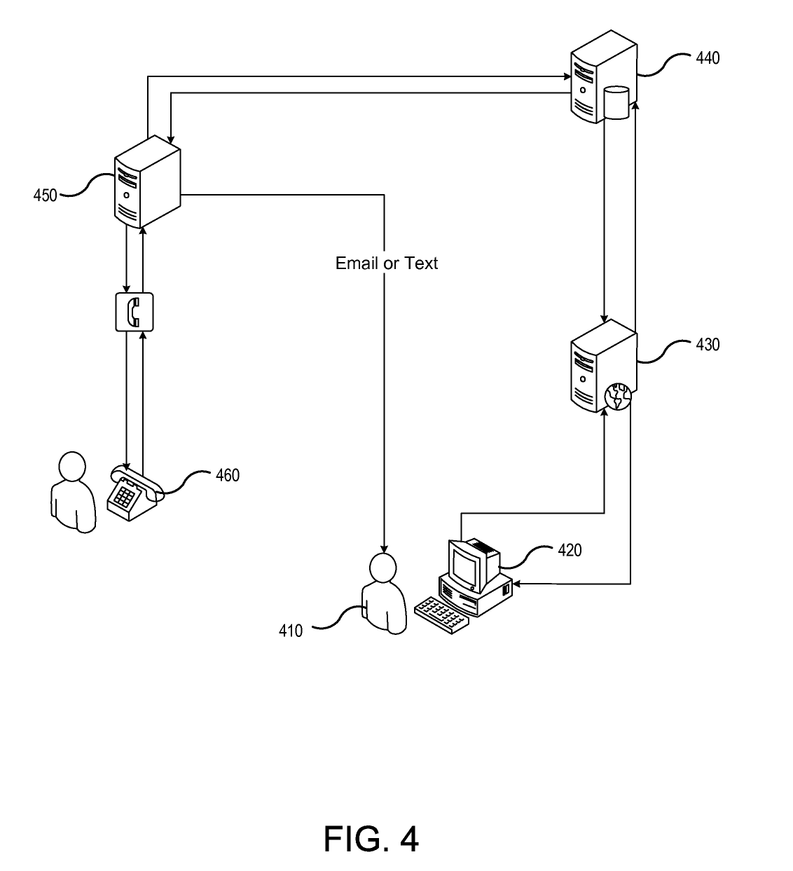

FIG. 4 illustrates a communication flow between various components and users of a medication monitoring system in accordance with some embodiments of the present invention. As illustrated in FIG. 4, caregiver 410 can use user device 420 to access a web-based portal for monitoring platform 120 (see, e.g., FIG. 1). User device 420 accesses webserver 430 to return a webpage for accessing monitoring platform 120. Caregiver 410 can then enter, edit, or delete information regarding a medication adherence schedule which can be stored in database server 440. Database server 440 runs one or more monitoring applications or modules that determine when a reminder should be sent. Upon determining that a reminder should be sent, database server 440 can request that call server 450 (e.g., CallFire) generates a reminder call to one or more specified phone numbers. In some embodiments, call server 450 can use various voice over Internet protocol systems to initiate communications with patient 460. As described in FIG. 1, the device used for communicating with patient 460 can be any communication device such as an ordinary telephone, a smart phone, a television, monitoring system, etc.

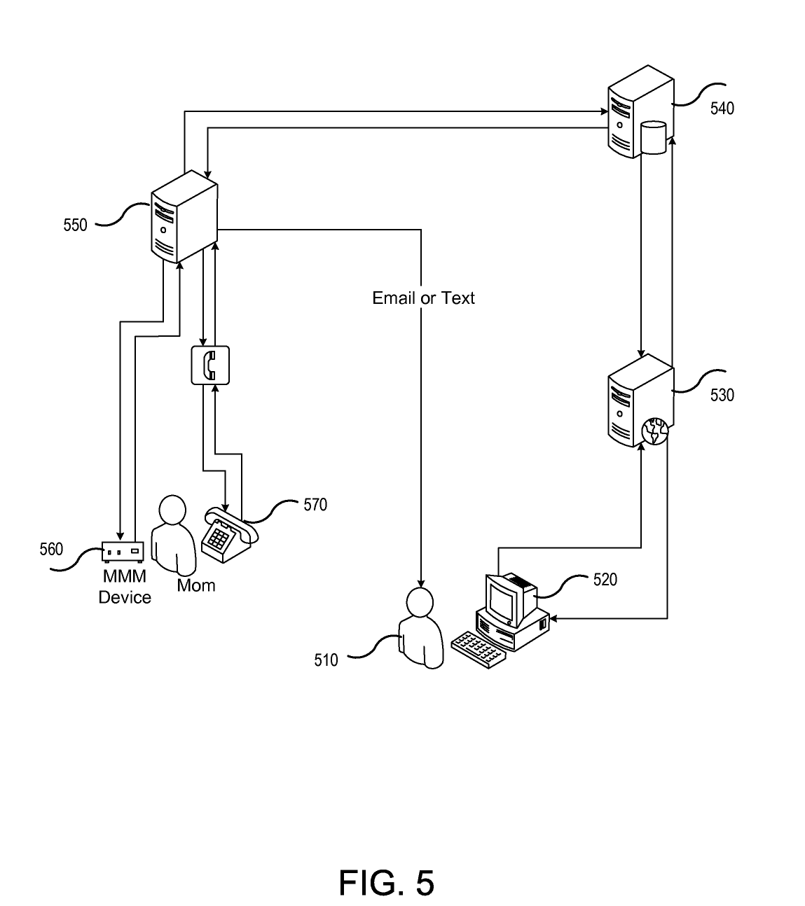

FIG. 5 illustrates a communication flow between various components and users of a medication monitoring system with an interactive medication dispensing device in accordance with one or more embodiments of the present invention. Similar to FIG. 4, caregiver 510 can use user device 520 to access a web-based portal for monitoring platform 120 (see, e.g., FIG. 1). User device 520 accesses webserver 530 to return a webpage for accessing monitoring platform 120. Caregiver 510 can then enter, edit, or delete information regarding a medication adherence schedule which can be stored in database server 540.

Database server 540 can run one or more monitoring applications or modules that determine when a reminder should be sent. Upon determining that a reminder should be sent, database server 540 can request that call and device server 550 (e.g., Providence) generates a reminder call or signal to one or more specified phone numbers and/or interactive monitoring devices 560. Interactive monitoring devices 560 can prompt the patient 570 for a response or generate a signal upon completion of an activity. For example, in some embodiments, interactive monitoring device 560 can include a medication dispensing device that generates an audible and/or visual signal for patient 570 to take a medication that is only dispensed upon interaction with the device (e.g., by pushing a button). A response signal may be generated by the device upon dispensing of the medication. In some embodiments, call server 550 can use various voice over Internet protocol systems to initiate voice communications with patient 570.

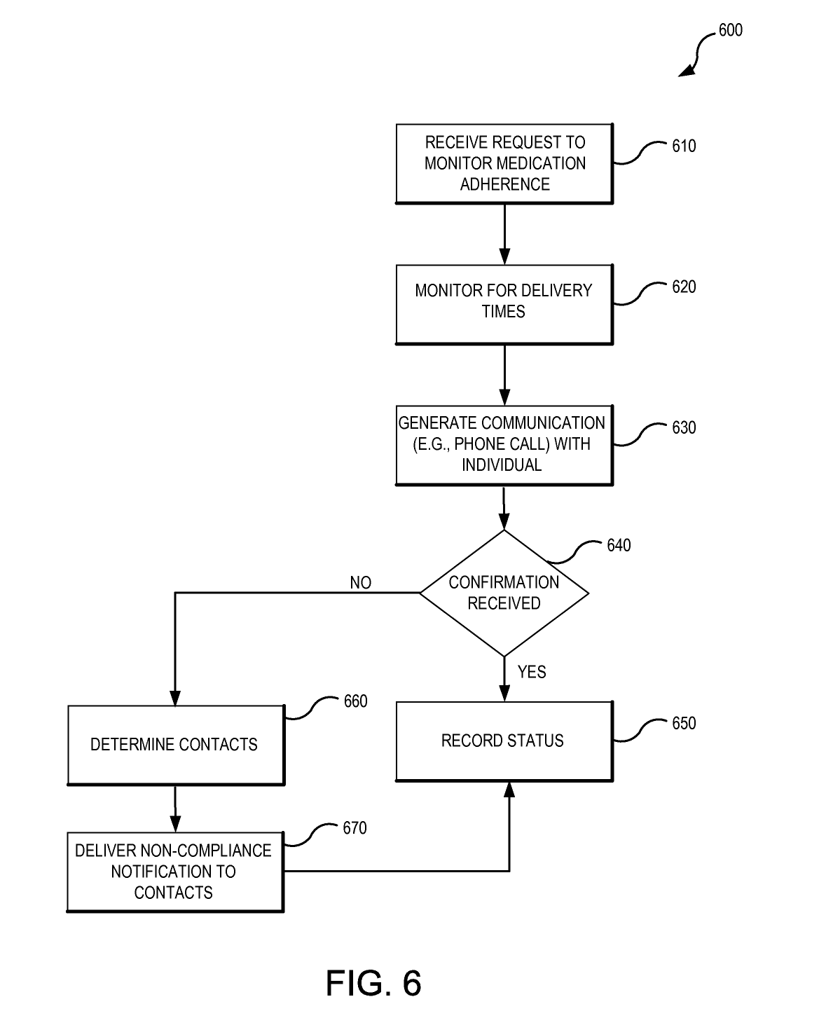

FIG. 6 is a flowchart illustrating a set of operations 600 for monitoring medication adherence in accordance with various embodiments of the present invention. The operations illustrated in FIG. 6 may be performed in one or more embodiments by various system components such as processor 320, communications module 330, records module 340, message module 350, reporting module 360, monitoring platform 120, medication dispensing device, and/or another component.

As illustrated in FIG. 6, receiving operation 610 receives a request to monitor medication adherence for one or more patients. The delivery times for the medications can be monitored during monitoring operation 620. Upon detection of a medication delivery time, communication operation 630 can deliver an automated communication (e.g., a personalized pre-recorded voice or video message). For example, communication operation 630 may attempt to call a telephone number associated with the patient and deliver the communication. In some cases, the patient may not pick up the phone, may pick up the phone but not provide any positive responses, or may respond to automated inquiries. Still yet, in other embodiments, the information regarding the medications and delivery times can be transferred to a medication dispensing device that will be responsible for generating reminders.

Confirmation operation 640 determines whether a confirmation was received. If confirmation operation 640 determines that a confirmation was received, the status can be recorded during recordation operation 650. If confirmation operation 640 determines that a confirmation was not received, confirmation operation 640 can branch to contact operation 660 where one or more contacts are determined. Delivery operation 670 can then deliver non-compliance notifications to the contacts. These notifications along with the original status are then recorded during recordation operation 650.

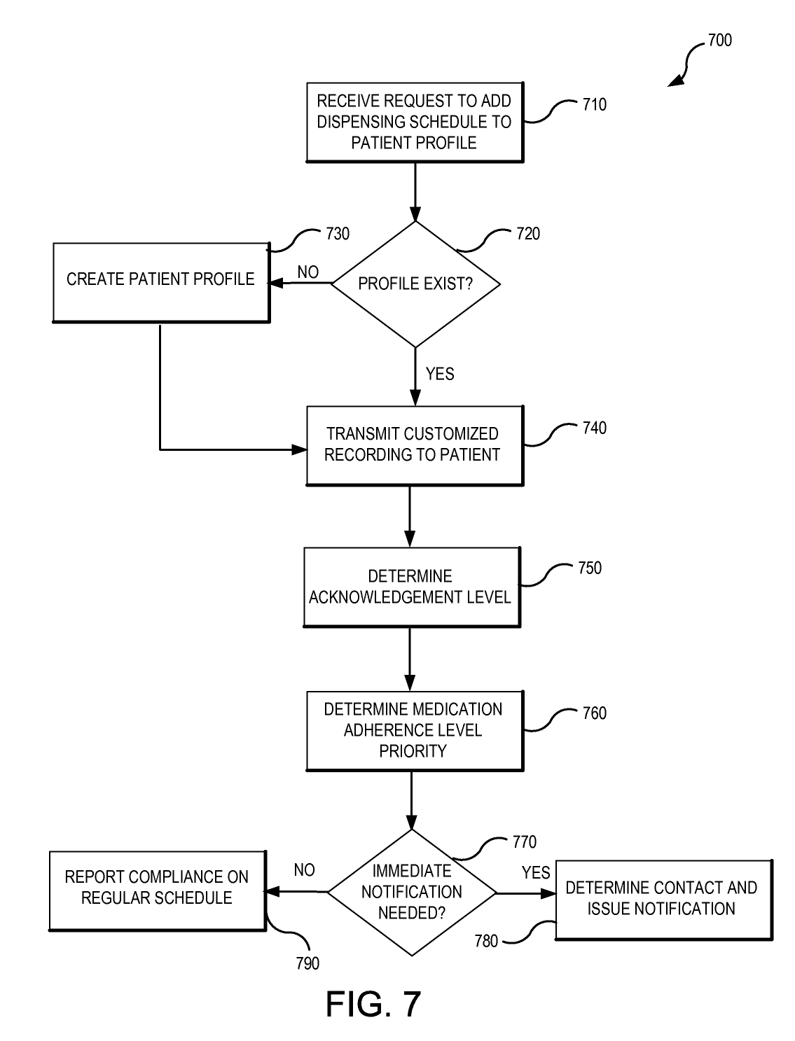

FIG. 7 is a flowchart illustrating a set of operations 700 for generating immediate notifications regarding medication adherence in accordance with various embodiments of the present invention. The operations illustrated in FIG. 7 may be performed in one or more embodiments by various system components such as processor 320, communications module 330, records module 340, message module 350, reporting module 360, monitoring platform 120, medication dispensing device, and/or another component.

As illustrated in FIG. 7, receiving operation 710 receives a request to add a dispensing schedule to a patient profile. The request may include a variety of information along with the dispensing schedule such as, but not limited to, a patient identifier identifying the patient, a medication identifier identifying a medication, medication adherence level priority, desired acknowledgement levels, caregiver contact information, caregiver contact rules, and/or other information. In some embodiments, one or more of these pieces of information may be requested from additional sources.

Determination operation 720 determines if the patient profile exists. If determination operation 720 determines that the patent profile does not exist, then determination operation 720 branches to creation operation 730 where a patient profile is created and the request is added to the patient profile. If determination operation 720 determines that the patent profile does exist, then the patient profile is updated to include the adherence request and determination operation 720 branches to transmission operation 740 where a customized reminder message is transmitted to the patient via a communication channel.

Acknowledgement operation 750 determines the acknowledgement level received. Multiple levels of acknowledgement may be tracked and used in making decisions of who and when to contact various caregivers. For example, when the customized reminder message is transmitted using a telephone, a first level of acknowledgement may be whether the patient answered the phone. The second level of acknowledgement may be a voice response indicating that the patient will take or has taken the medication. A third level of acknowledgment may include a signal from a medication dispensing device indicating whether the patient requested the medication be dispensed. Of course, a variety of other and/or different acknowledgment levels may be used by various embodiments.

Priority operation 760 determines the medication adherence level priority of the medication. For example, some embodiments may include three or more priority levels. In those embodiments, the lowest priority level may not require any notification at all when a patient does not acknowledge or provide feedback regarding adherence. This may be useful for medications that are not critical to the patient's health (e.g., vitamins). A second level may require a notification when a patient misses more than a specified number within a period of time. A third level may require a notification anytime the medication is not dispensed and a positive indication is received from the patient that they will take the medication. In some cases, a lack of acknowledgment of the customized reminder message may be communicated (e.g., immediately) to a caregiver associated with the patient. For example, the lack of acknowledgment may be communicated immediately when the medication has an adherence level priority rating above a threshold or when the level of acknowledgement is below a threshold level (e.g., if the patient did not answer the phone).

Notification determination operation 770 can use the acknowledgement level and the medication adherence level priority to determine if a contact or caregiver should be notified. If determination operation 770 determines that immediate notification is needed, then determination operation 770 branches to contact operation 780 where a contact is determined and the appropriate notification is issued. If determination operation 770 determines that no immediate notification is needed, then determination operation 770 branches to reporting operation 790 where compliance (or lack thereof) is reported on regular schedule or upon access by a caregiver.

FIGS. 8-28 illustrate various graphical user interfaces that may be used in accordance with some embodiments of the present invention. The graphical user interfaces illustrated in these figures can provide some of the means for performing various functions as described in more detail below. These graphical user interfaces may be used as part of a program that allows families and caregivers to help manage medications, routine healthcare activities, and activities of daily living of a loved one or patient. The graphical user interfaces provide a way to setup an easy-to-use reminder system, using personal recorded messages from the caregiver. The monitoring service can monitor the user's response that the message was received and present a summary through the graphical user interface screens. The monitoring service can keep track of a complete medication list, including vitamins and supplements, along with the times the medications should be and were taken by a patient. In some embodiments, reminder messages can be setup separately from the medication schedule. The medication schedule can provide a user/caregiver the option to associate reminders or just view the medication schedules for the patient all in one convenient location.

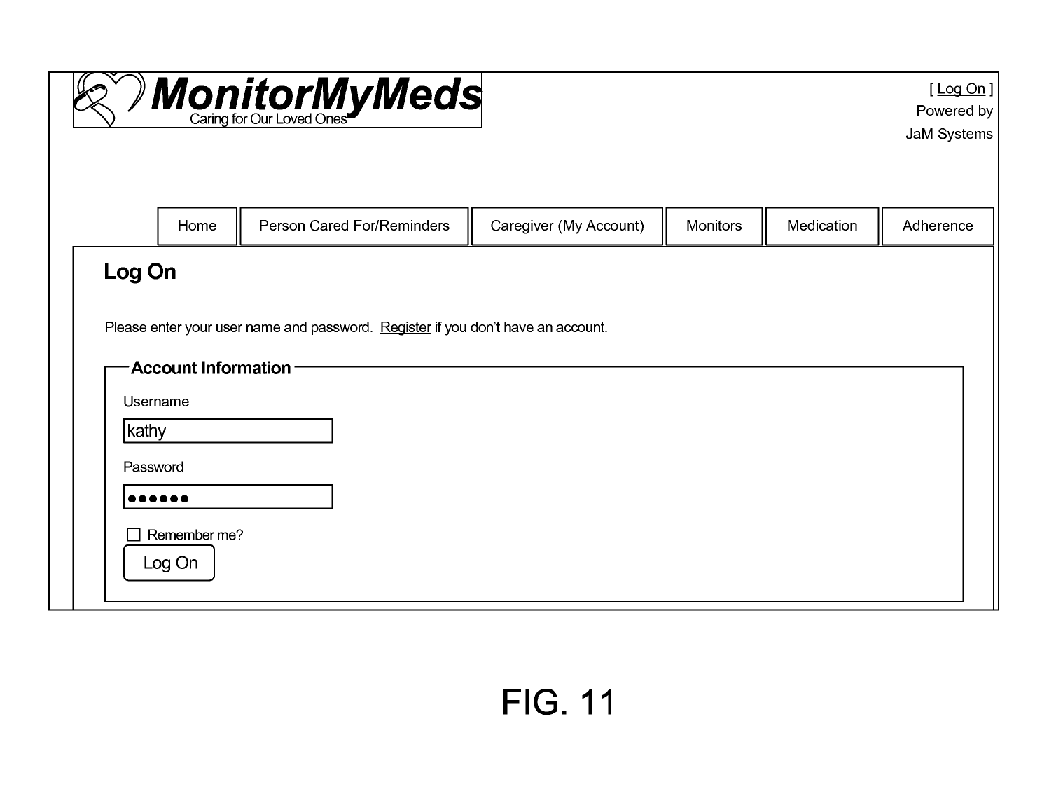

FIGS. 8-10 illustrate an account setup wizard that provides a quick and convenient way to enter information about the caregiver, the person being cared for, and up to three monitors that can be set up to receive text messages, e-mails, or both about the response of the person being cared for, including a 24/7 monitoring company if needed. After entering the monitoring information, a user can save the changes and go to a log on page as illustrated by FIG. 11. Entering the user name and password will set up the account.

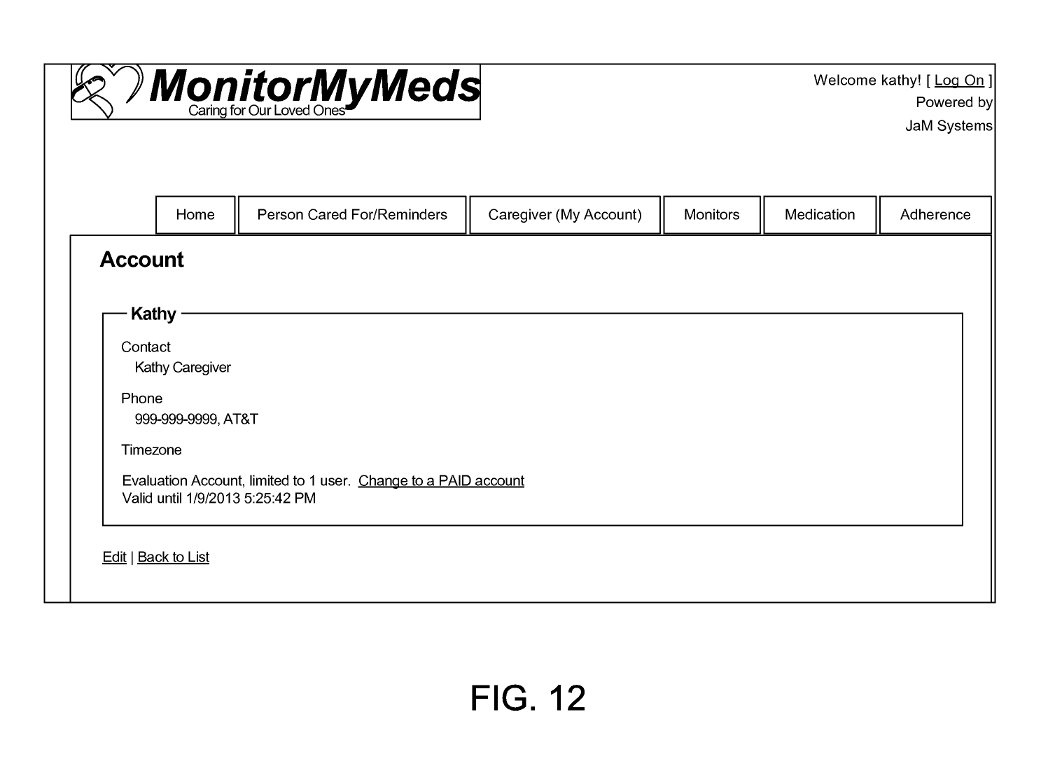

FIG. 12 shows six tabs along the top. The Person Cared For/Reminders, Caregiver (My Account), and Monitors tabs contain the information previously provided in the setup wizard but have additional fields for other information if a user chooses to fill them in. In accordance with various embodiments, all information can be edited at any time.

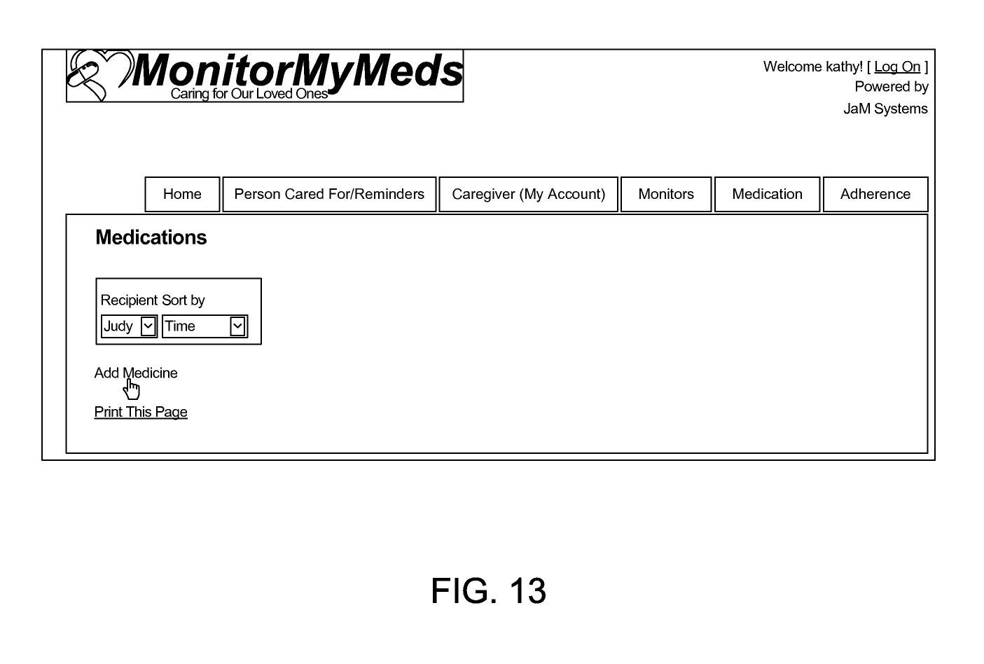

FIGS. 13-17 illustrate various graphical user interface screens that may be presented to the user in response to setting up medications through the selection of the Medication tab. These graphical user interface screens allow the user to keep track of the medication schedule of the person cared for. Medications can be set up by clicking on Add Medicine and entering the information. The prescription might be daily, specific days of the week, or skip days such as every third day in this example. The schedule can be sorted by time or by medicine. It can be a guide for setting medication reminders as well as keeping a current medication schedule to share with other healthcare providers.

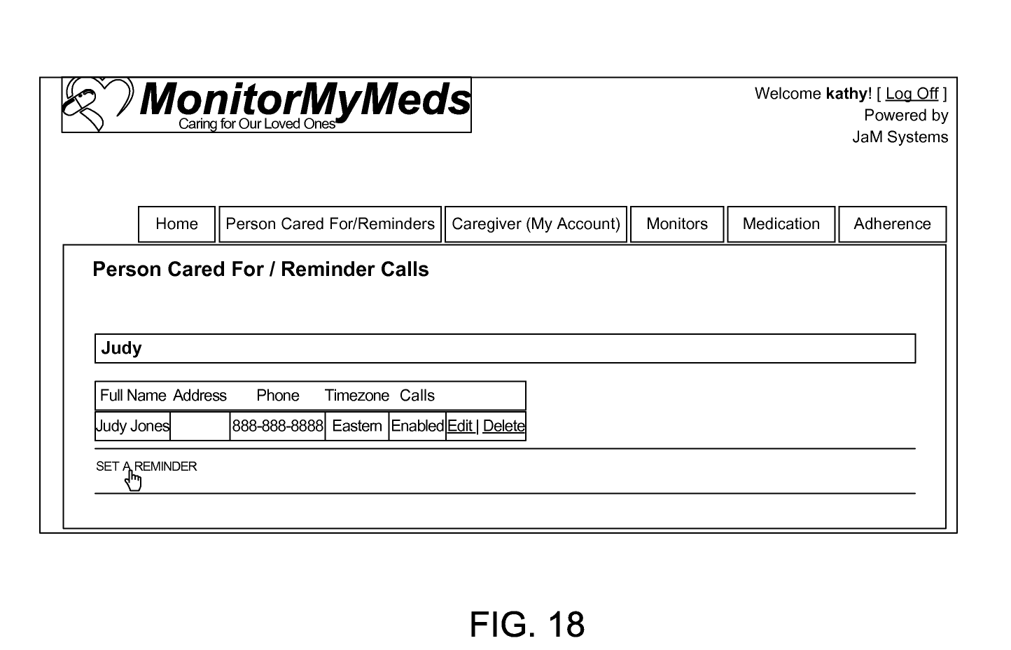

FIGS. 18-22 illustrate various graphical user interface screens that may be presented to the user in response to selection of the Person Cared For/Reminders tab. As illustrated in these figures, a user of the monitoring service may record a message (e.g., using a microphone and an application of a computing device for recording) by clicking on Set A Reminder in the Person Cared For/Reminders tab. The user can label the call, set the time of delivery of the message, set who will monitor the message and what alert they will receive, determine the start and end date of the message, and at what interval it will be delivered. By clicking on the Record a Reminder button at the bottom a user can record a message in the record window. When satisfied with the recording, the user can save it, and the message will be scheduled for delivery to the person cared for. The user can edit, delete, or change the message at any time. As reminders are sent and responded to, the Adherence tab will show that the person cared for has affirmatively responded by displaying a green check mark, that they did not respond by a red X, or that the reminder message went to a voice mail by a “VM”.

Other embodiments may also use other applications or methods for capturing the customized/personalized reminder message. For example, in one embodiment, caregivers associated with a patient may be issued an e-mail address. The e-mail address may be automatically issued or issued upon request from the caregiver or other person that would like to generate a reminder for the patient. The caregiver or other person can record a message using any device or mobile application and e-mail the recording (e.g., video recording or audio recording) to the monitoring platform. The message can then be added to an account associated with the e-mail address. The message can then be selected and associated with a medication dispensing schedule or given an independent delivery schedule.

As another example, in some embodiments, the monitoring platform may allow a telephone call to be scheduled to an individual that would like to record a message. The telephone call can be scheduled to occur immediately or at a future date and time. When the individual answers the telephone call, the individual can be prompted to record a message. The message can then be added to the account. The message can then be selected and associated with a medication dispensing schedule or given an independent delivery schedule to provide personalized reminders to the patient to take their medication and/or perform another medical activity (e.g., record blood pressure, measure body weight, record body temperature, record a pulse rate, etc.).

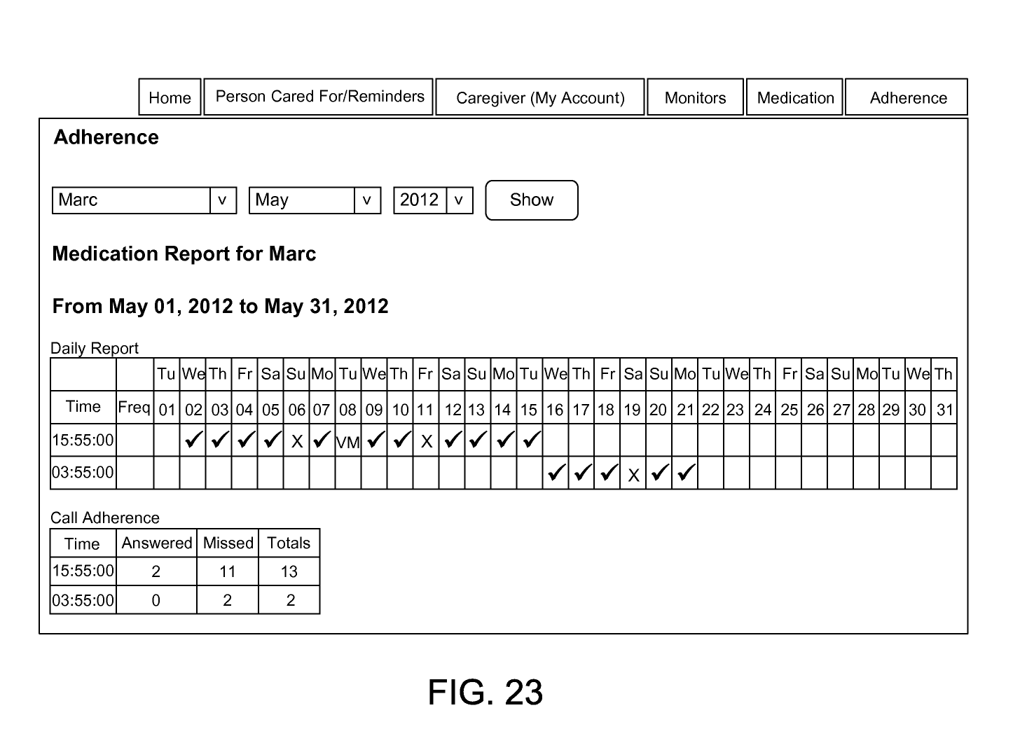

FIG. 23 illustrates a graphical user interface screen that may be presented to the user in response to selection of the Adherence tab. As illustrated in FIG. 23, a medication report can be generated for a selected time period (e.g., one-month time period, previous six months, etc.). The report may aggregate the tracking of multiple medications or provide tracking of a single medication. In some embodiments, different visual indicators (e.g., checkmarks and x′s) may be used to show compliance/noncompliance or responses from the patient. In some cases, other visual indicators may be used to show when the monitoring system was directed to voicemail or received no response.

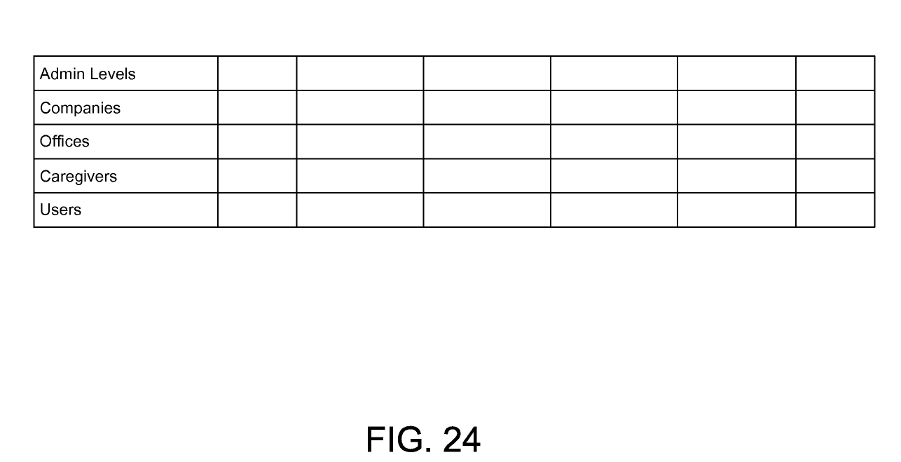

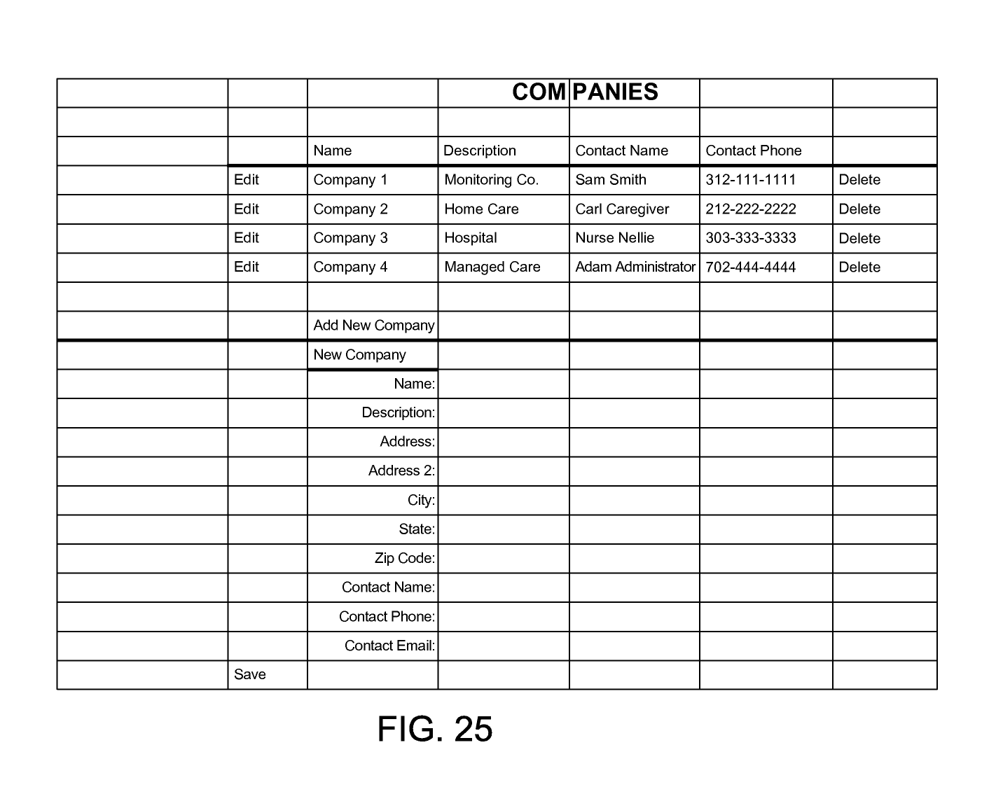

FIGS. 24-28 illustrate representations of user management of monitoring platform 120. FIG. 24, for example, illustrates various administration levels or categories of users (e.g., companies, offices, caregivers, and users) each possibly having different privileges within the system. Depending on the administration level assigned to a user, the user may be able to review and manage information for multiple patients. FIGS. 25-28 illustrate the types of information that may be added for management, registration, and tracking of multiple companies, caregivers, offices, and patients.

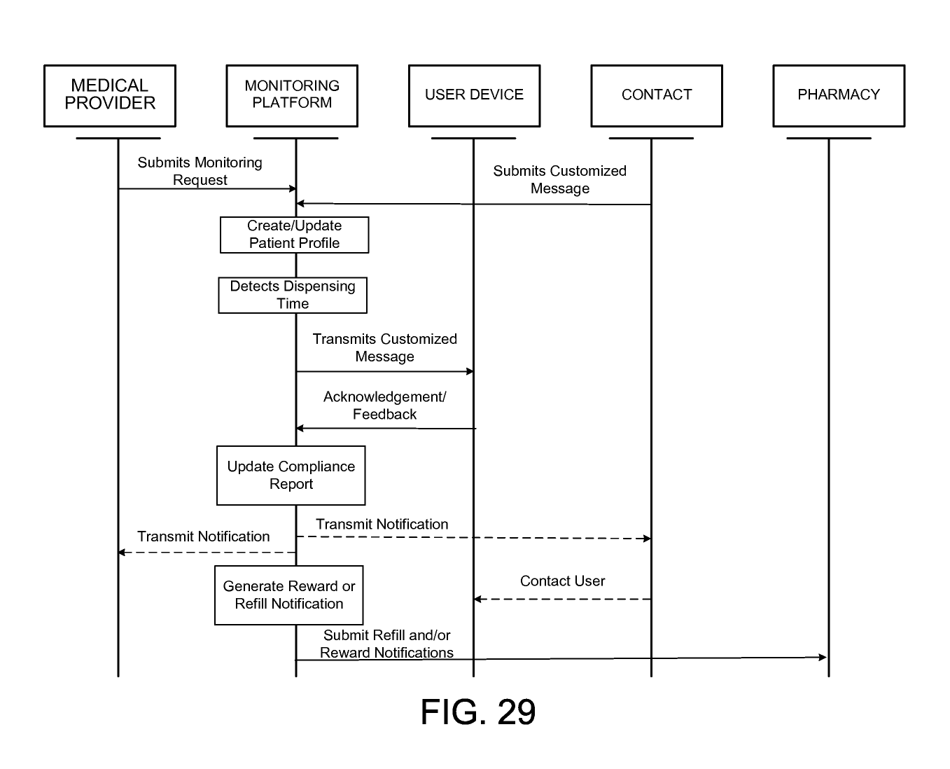

FIG. 29 is a sequence diagram illustrating various communications between components and users of a medication adherence system. As illustrated in FIG. 29, a medical provider may submit a medication adherence monitoring request to a monitoring platform. The monitoring platform may be a localized device or a web-based platform capable of monitoring individual medication dispensing signals and generating customized reminders. Various contacts or caregivers may submit customized recordings or messages to the monitoring platform. The monitoring platform may update the user profile with the medication adherence monitoring request and/or the customized recording or messages that are received. Once updated, the monitoring platform can setup triggers that cause the generation of a customized message to be sent from the monitoring platform to the user device upon detection of a triggering event (e.g., a time and date, confirmation of taking of a sequence of medications, etc.).

Various types of acknowledgement or feedback may be provided by the user or user device (e.g., confirmation of message being heard/read/played or a voice acknowledgement). The acknowledgement or feedback may be used to generate or update a compliance report. In accordance with various embodiments, a notification can be transmitted to one or more caregivers or medical providers that indicate positive and/or negative confirmation that the user took the medication. The caregiver or medical provider can then contact the patient as desired. In addition, the monitoring platform can determine, based on the compliance report, whether rewards should be granted and if an automatic prescription renewal should be submitted to a pharmacy.

### Exemplary Computer System Overview

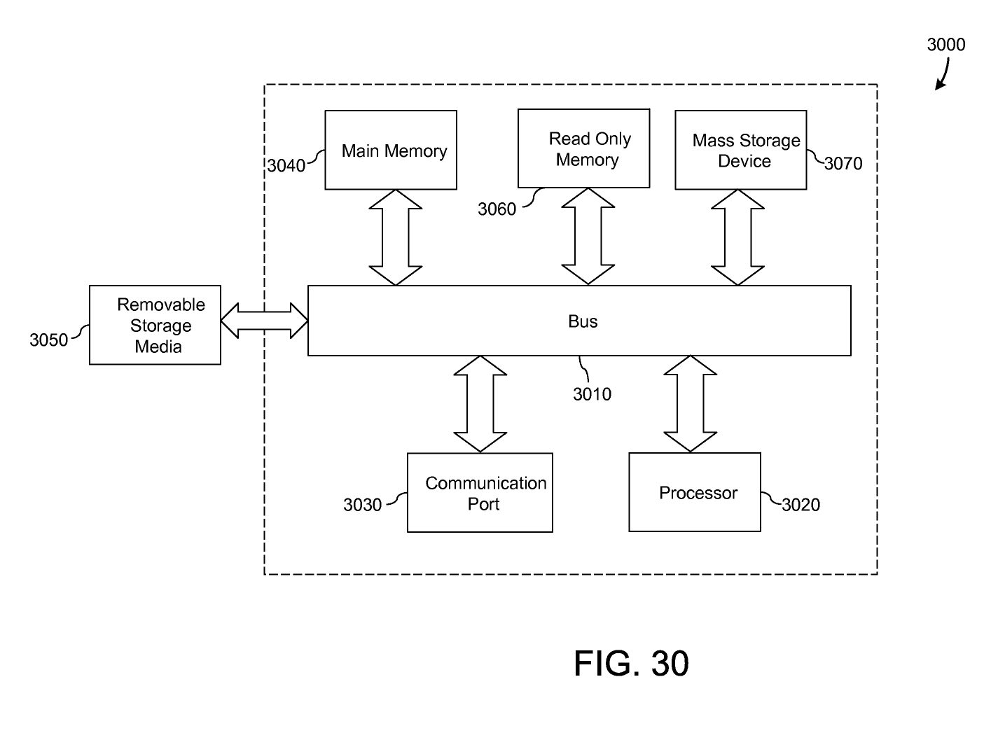

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 30 is an example of a computer system 3000 with which embodiments of the present invention may be utilized. According to the present example, the computer system includes a bus 3010, at least one processor 3020, at least one communication port 3030, a main memory 3040, a removable storage media 3050, a read only memory 3060, and a mass storage 3070.

Processor(s) 3020 can be any known processor, such as, but not limited to, Intel® lines of processors, ARM lines of processors, AMD® lines of processors, or Motorola® lines of processors. Communication port(s) 3030 can be any of an RS-232 port for use with a modem-based dialup connection, a 10/100 Ethernet port, or a Gigabit port using copper or fiber. Communication port(s) 3030 may be chosen depending on a network such as a Local Area Network (LAN), Wide Area Network (WAN), or any network to which the computer system 3000 connects.

Main memory 3040 can be Random Access Memory (RAM) or any other dynamic storage device(s) commonly known in the art. Read only memory 3060 can be any static storage device(s) such as Programmable Read Only Memory (PROM) chips for storing static information such as instructions for processor 3020.

Mass storage 3070 can be used to store information and instructions. For example, hard disks such as the Adaptec® family of SCSI drives, an optical disc, an array of disks such as RAID, such as the Adaptec family of RAID drives, or any other mass storage devices may be used.

Bus 3010 communicatively couples processor(s) 3020 with the other memory, storage, and communication blocks. Bus 3010 can be a PCI/PCI-X- or SCSI-based system bus depending on the storage devices used.

Removable storage media 3050 can be any kind of external hard-drives, floppy drives, IOMEGA® Zip Drives, Compact Disc-Read Only Memory (CD-ROM), Compact Disc-Re-Writable (CD-RW), and/or Digital Video Disk-Read Only Memory (DVD-ROM).

The components described above are meant to exemplify some types of possibilities. In no way should the aforementioned examples limit the scope of the invention, as they are only exemplary embodiments.

In conclusion, various embodiments of the present invention provide novel systems, methods, and arrangements for medication adherence. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features.

what is claimed is:

1. A computer-implemented method comprising:
receiving, at a monitoring platform, a request to monitor medication adherence of a patient, wherein the request to monitor medication adherence includes a patient identifier identifying the patient, a medication identifier identifying a medication, and a dispensing schedule identifying dispensing times;
storing, in a database associated with the monitoring platform, the request to monitor medication adherence of the patient;
determining, at the monitoring platform, if a dispensing time indicated in the dispensing schedule is within a predetermined time interval or has occurred;
selecting, upon detecting the dispensing time is within the predetermined time interval or has occurred, a communication channel to communicate with the patient;
generating, at the monitoring platform, a customized reminder message that includes a recording of an individual trusted by the patient reminding the patient to adhere to the dispensing schedule and requesting the patient to provide feedback regarding compliance;
transmitting, using the communication channel, the customized reminder message to the patient;
monitoring the communication channel to determine if the patient provides feedback regarding compliance in response to receiving the customized reminder message;
recording the feedback provided by the patient through the communication channel to generate a compliance record; and
notifying a set of caregivers associated with the patient, wherein at least a portion of the compliance record is communicated to the set of caregivers.

2. The computer-implemented method of claim 1, wherein notifying the set of caregivers occurs immediately when the patient fails to provide feedback or the feedback includes an indication of non-compliance.

3. The computer-implemented method of claim 1, wherein the medication is associated with an adherence level priority rating.

4. The computer-implemented method of claim 3, wherein if the adherence level priority rating is above a threshold and the patient fails to provide feedback or the feedback includes an indication of non-compliance, the set of caregivers are notified immediately.

5. The computer-implemented method of claim 3, wherein if the adherence level priority rating is below a threshold, the set of caregivers are notified on a predetermined schedule.

6. The computer-implemented method of claim 1, wherein notifying the set of caregivers includes determining a first caregiver to notify and only contacting one or more other caregivers if the first caregiver does not respond.

7. The computer-implemented method of claim 1, wherein the recording of the individual trusted by the patient is a video recording or an audio recording.

8. The computer-implemented method of claim 1, wherein the communication channel includes a telephone, a mobile device, or a medication dispensing device.

9. A system comprising:
a processor;
a message module running on the processor to allow a caregiver to create a customized message reminding a patient to take a medication at a dispensing time;
a communications module to transmit the customized message to a device of the patient and determine if the patient acknowledges the customized message;
a records module to record any acknowledgement determined by the communications module.

10. The system of claim 9, further comprising a natural language processor to process voice responses received from the patient.

11. The system of claim 9, wherein the customized message includes a video recording or an audio recording.

12. The system of claim 9, wherein the communications module receives a dispensing schedule from a doctor indicating a medication and a set of dispensing times indicating when the patient should take the medication.

13. The system of claim 9, wherein the customized message also includes a reminder to perform a medical activity.

14. The system of claim 13, wherein the medical activity includes taking blood pressure, measuring body weight, performing an exercise, measuring body temperature, measuring a pulse rate, or recording qualitative indicators indicating how the patient is feeling.

15. The system of claim 9, further comprising a rewards module to determine a reward based on a compliance percentage over a time period.

16. The system of claim 15, wherein the reward includes medication discounts.

17. The system of claim 9, wherein the acknowledgement is an indication from a medication dispensing device that the patient has requested that the medication be dispensed.

18. The system of claim 9, further comprising a graphical user interface generation module that generates a first graphical user interface screen that allows a patient profile to be created and generates a second graphical user interface screen that shows acknowledgments received over time.

19. A medication adherence system comprising:
means for creating a medication adherence profile for a patient, wherein the medication adherence profile includes a patient identifier identifying the patient, a medication identifier identifying a medication, a dispensing schedule identifying dispensing times for the medication, a set of caregivers, and set of criteria for notifying the caregivers;
means for determining if a dispensing time indicated in the dispensing schedule is within a predetermined time interval or has occurred;
means for generating a customized reminder message that includes a recording of an individual trusted by the patient reminding the patient to adhere to the dispensing schedule and requesting the patient to provide feedback regarding compliance;
means for monitoring for feedback from the patient regarding compliance in response to receiving the customized reminder; and
means for generating a compliance record based on the feedback provided by the patient.

20. The medication adherence system of claim 19, further comprising means for communicating the compliance record with the caregivers.

21. The medication adherence system of claim 19, further comprising means for selecting, upon detecting the dispensing time is within the predetermined time interval or has occurred, a communication channel to communicate with the patient.

22. The medication adherence system of claim 19, further comprising means for determining a reward for the patient based on the compliance record.

23. The medication adherence system of claim 19, wherein the feedback from the patient includes a request at a medication dispensing device to dispense the medication.

24. The medication adherence system of claim 19, wherein the feedback includes a voice acknowledgement.

25. A computer-implemented method comprising:
determining if a patient should be contacted with a customized reminder message, wherein the customized reminder message includes a recording of an individual trusted by the patient reminding the patient to take a medication and requesting the patient to provide feedback regarding compliance;
transmitting the customized reminder message to the patient;
determining if the patient acknowledges the customized reminder message; and
communicating a lack of acknowledgment of the customized reminder message to a caregiver associated with the patient.

26. The computer-implemented method of claim 25, wherein communicating the lack of acknowledgment occurs immediately when the medication has an adherence level priority rating above a threshold.

27. The computer-implemented method of claim 25, wherein the recording of the individual trusted by the patient is a video recording or an audio recording.
